(19) United States
(12) Patent Application Publication
(10) Pub. No.: US 2022/0284523 A1
(43) Pub. Date: Sep. 8, 2022

(54) CONTROL SYSTEM FOR COLLECTING SENSOR AND DEVICE PAIRING DATA

(71) Applicant: State Farm Mutual Automobile Insurance Company, Bloomington, IL (US)

(72) Inventors: Scott Christensen, Salem, OR (US); Greg Hayward, Bloomington, IL (US); Jeffrey Kinsey, Bloomington, IL (US); Jeffrey W. Stoiber, Bloomington, IL (US)

(21) Appl. No.: 17/824,664

(22) Filed: May 25, 2022

Related U.S. Application Data
(63) Continuation of application No. 15/597,964, filed on May 17, 2017.
(60) Provisional application No. 62/345,527, filed on Jun. 3, 2016.

(51) Int. Cl. G06Q 50/16; G06Q 30/04; G06Q 40/08

(52) U.S. Cl. CPC G06Q 50/16; G06Q 30/04; G06Q 40/08; G06Q 30/0645

(57) ABSTRACT

A control system includes a server computing device and a control hub. The control hub is in communication with the server computing device and with a distributed network of telematics devices and a wireless communication device physically located at a property. Each telematics device includes a sensor and collects sensor data representing utility consumption. The wireless communication device collects wireless pairing data including timestamps associated with wireless pairing of the wireless communication device with any user computing device. The control hub receives sensor data and wireless pairing data, and transmits the same to the server computing device, which processes the received data to associate portions of an overall utility usage at the property with a presence of user computing devices, and displays, within a graphical user interface of an application executed on each user computing device, the portion of utility usage associated with the presence of that user computing device.

### CROSS-REFERENCE TO RELATED APPLICATIONS

This application is a continuation application of U.S. patent application Ser. No. 15/597,964, filed May 17, 2017, which claims the benefit of priority to U.S. Provisional Pat. App. No. 62/345,527, filed Jun. 3, 2016, the entire contents of each of which are hereby incorporated by reference herein in their entirety.

### FIELD OF THE DISCLOSURE

The present disclosure generally relates to a control system and, more particularly, to control systems and methods for collecting sensor and device pairing data to determine energy usage at a shared property.

### BACKGROUND

In some cases, personal or residential property may be leased or rented to groups of two or more people. Similarly, some commercial property may also be shared between businesses. Sometimes, these “co-leasing” situations present issues for the lessees in dividing and allocating certain costs associated with the property between lessees. In one particular example, insurance costs may be difficult to divide, as current insurance products (e.g., policies, such as renter's insurance policies) are not designed to be shared between separate parties.

### BRIEF SUMMARY

The present embodiments may relate to control systems and methods for collecting sensor and device pairing data to determine energy or utility usage within a shared property. Based on the determined utility usage, dividing and allocating property costs between multiple property users of a property, such as roommates or businesses occupying space within a building. A shared property system including a property cost allocation (PCA) computing device may receive and process property policies that describe how a set of property users will have property costs allocated therebetween. The PCA computing device may then track usage of the property by each property user and, according to the usage and the property policies, allocate a portion of a total operating cost of the property to each property user. In some embodiments, the PCA computing device may also manage payment of those property costs on behalf of the property users.

In one aspect, a control system for detecting utility usage using sensor and device pairing data includes a server computing device including a first memory and a first processor, and a control hub physically located at a property. The control hub is in communication with the server computing device, with a distributed network of telematics devices physically located at the property, and with at least one wireless communication device physically located at the property. Each telematics device includes a respective utility sensor and configured to collect sensor data representing utility consumption and including timestamps associated with the utility consumption. The at least one wireless communication device is configured to collect wireless pairing data including timestamps associated with wireless pairing of the wireless communication device with any user computing device. The control hub includes a second memory and a second processor. The second processor is programmed to: (i) continuously receive, from the distributed network of telematics devices, sensor data; (ii) continuously receive, from the wireless communication device, wireless pairing data; and (iii) periodically transmit, to the server computing device, the sensor data and wireless pairing data. The first processor is programmed to: (a) generate, by processing the received sensor data and wireless pairing data using trained machine learning functionality stored within the first memory, a presence profile for each user computing device, the presence profile representing physical presence of a corresponding user of the respective user computing device at the property; (b) identify, in the received sensor data and wireless pairing data, a presence anomaly; (c) in response to identifying the presence anomaly, transmit a confirmation request to at least one of the user computing devices; (d) update the presence profile for each property user computing device using the trained machine learning functionality and a response to the confirmation request; and (e) cause to be displayed, within a graphical user interface of an application executed on each respective user computing device, a respective portion of the overall utility usage associated with the presence profile of that user computing device.

In another aspect, a computer-implemented method for detecting utility usage using sensor and device pairing data is method implemented by a control system including a server computing device having a first memory and a first processor, and a control hub physically located at a property, the control hub including a second memory and a second processor. The computer-implemented method includes: (i) communicatively coupling the control hub to the server computing device, to a distributed network of telematics devices physically located at the property, and to at least one wireless communication device physically located at the property, each telematics device including a respective utility sensor and configured to collect sensor data representing utility consumption and including timestamps associated with the utility consumption, the at least one wireless communication device configured to collect wireless pairing data including timestamps associated with wireless pairing of the wireless communication device with any user computing device; (ii) continuously receiving, by the control hub from the distributed network of telematics devices, sensor data; (iii) continuously receiving, by the control hub from the wireless communication device, wireless pairing data; (iv) periodically transmitting, by the control hub to the server computing device, the sensor data and wireless pairing data; (v) generating, by the server computing device by processing the received sensor data and wireless pairing data using trained machine learning functionality stored within the first memory, a presence profile for each user computing device, the presence profile representing physical presence of a corresponding user of the respective user computing device at the property; (vi) identifying, by the server computing device in the received sensor data and wireless pairing data, a presence anomaly; (vii) in response to identifying the presence anomaly, transmitting, by the server computing device, a confirmation request to at least one of the user computing devices; (viii) updating, by the server computing device, the presence profile for each property user computing device using the trained machine learning functionality and a response to the confirmation request; and (ix) causing to be displayed, by the server computing device within a graphical user interface of an application executed on each respective user computing device, a respective portion of the overall utility usage associated with the presence profile of that user computing device.

In a further aspect, at least one non-transitory computer-readable storage medium having computer-executable instructions embodied thereon is provided. When executed by a first processor of a server computing device and a second processor of a control hub physically located at a property—the control hub in communication with the server computing device, with a distributed network of telematics devices physically located at the property, and with at least one wireless communication device physically located at the property, each telematics device including a respective utility sensor and configured to collect sensor data representing utility consumption and including timestamps associated with the utility consumption, the at least one wireless communication device configured to collect wireless pairing data including timestamps associated with wireless pairing of the wireless communication device with any user computing device—the computer-executable instructions cause the first and second processors to: (i) continuously receive, by the second processor from the distributed network of telematics devices, sensor data; (ii) continuously receive, by the second processor from the wireless communication device, wireless pairing data; (iii) periodically transmit, by the second processor to the server computing device, the sensor data and wireless pairing data; (iv) generate, by the first processor by processing the received sensor data and wireless pairing data using trained machine learning functionality stored within the first memory, a presence profile for each user computing device, the presence profile representing physical presence of a corresponding user of the respective user computing device at the property; (v) identify, by the first processor in the received sensor data and wireless pairing data, a presence anomaly; (vi) in response to identifying the presence anomaly, transmit, by the first processor, a confirmation request to at least one of the user computing devices; (vii) update, by the first processor, the presence profile for each property user computing device using the trained machine learning functionality and a response to the confirmation request; and (viii) cause to be displayed, by the first processor within a graphical user interface of an application executed on each respective user computing device, a respective portion of the overall utility usage associated with the presence profile of that user computing device.

In one aspect, a property cost allocation (PCA) computing device for allocating property costs between users of a property may be provided. The PCA computing device may include a memory and a processor. The processor may be programmed to receive telematics device records from a property telematics unit associated with the property. The telematics device records may describe usage of one or more telematics (or smart) devices associated with the property by at least one property user of a plurality of property users over an interval of time. The processor may also be programmed to generate a total property usage report based at least in part upon the telematics device records, wherein the total property usage report describes the total usage of the property by the plurality of property users over the interval of time. The processor may be further programmed to determine one or more total property costs associated with the property over the interval of time based at least in part upon the total property usage report, and determine a respective portion of each total property cost attributable to each property user of the plurality of property users based at least in part upon the telematics device records and the total property cost. The processor may also be programmed to allocate each respective portion of each total property cost to the corresponding property user. The processor may be programmed to perform additional, fewer, or alternative actions, including those discussed elsewhere herein.

In another aspect, a computer-implemented method for allocating property costs between users of a property, as well as improving the functionality of a computer or computer system, may be provided. The method may be implemented using a property cost allocation (PCA) computing device including a processor in communication with a memory. The method may include, via the processors and/or an associated transceiver, receiving telematics device records from a property telematics unit associated with the property (such as via wireless communication or data transmission over one or more radio links or wireless communication channels). The telematics device records may describe usage of one or more telematics (or smart) devices associated with the property by at least one property user of a plurality of property users over an interval of time. The method may also include generating a total property usage report based at least in part upon the telematics device records, wherein the total property usage report describes the total usage of the property by the plurality of property users over the interval of time, and determining one or more property costs associated with the property over the interval of time based at least in part upon the total property usage report. The method may further include determining a respective portion of each property cost attributable to each property user of the plurality of property users based at least in part upon the telematics device records and the property cost, and allocating each respective portion of each property cost to the corresponding property user (and communicating such to one or more user mobile devices via wireless communication or data transmission over one or more radio links or communication channels). The method may include additional, fewer, or alternative actions, including those discussed elsewhere herein.

In yet another aspect, at least one non-transitory computer-readable storage media having computer-executable instructions embodied thereon may be provided. When executed by one or more processors, the computer-executable instructions may cause the one or more processors to receive telematics device records from a property telematics unit associated with the property. The telematics device records may describe usage of one or more telematics (or smart) devices associated with the property by at least one property user of a plurality of property users over an interval of time. The computer-executable instructions may also cause the processor to generate a total property usage report based at least in part upon the telematics device records, wherein the total property usage report describes the total usage of the property by the plurality of property users over the interval of time. The computer-executable instructions may further cause the processor to determine one or more total property costs associated with the property over the interval of time based at least in part upon the total property usage report, and determine a respective portion of each total property cost attributable to each property user of the plurality of property users based at least in part upon the telematics device records and the total property cost. The computer-executable instructions may also cause the processor to allocate each respective portion of each total property cost to the corresponding property user. The computer-executable instructions may cause the one or more processors to perform additional, fewer, or alternative actions, including those discussed elsewhere herein.

In a further aspect, a property cost allocation (PCA) computing device for allocating property costs between users of a property may be provided. The PCA computing device may include a memory and a processor. The processor may be programmed to receive telematics device records from a property telematics unit associated with the property (such as via wireless communication or data transmission over one or more radio links or wireless communication channels). The telematics device records may describe usage of one or more telematics devices, and/or smart devices associated with the property by at least one property user of a plurality of property users over an interval of time. The processor may also be programmed to generate a presence profile for each property user of the plurality of property users based at least in part upon the telematics device records, the presence profile describing the presence of the respective property user at the property over the period of time. The processor may be further programmed to determine a respective portion of a property cost associated with the property over the interval of time attributable to the presence of each property user of the plurality of property users based at least in part upon the respective presence profiles, and allocate the respective portion of the property cost to the corresponding property user. The processor may be programmed to perform additional, fewer, or alternative actions, including those discussed elsewhere herein.

In another aspect, a computer-implemented method for allocating property costs between users of a property may be provided. The method may be implemented using a property cost allocation (PCA) computing device including a processor in communication with a memory. The method may include, via the processors and/or an associated transceiver, receiving telematics device records from a property telematics unit associated with the property (such as via wireless communication or data transmission over one or more radio links or wireless communication channels). The telematics device records may describe usage of one or more telematics devices, and/or smart devices, associated with the property by at least one property user of a plurality of property users over an interval of time. The method may also include generating a presence profile for each property user of the plurality of property users based at least in part upon the telematics device records, the presence profile describing the presence of the respective property user at the property over the period of time. The method may further include determining a respective portion of a property cost associated with the property over the interval of time attributable to the presence of each property user of the plurality of property users based at least in part upon the respective presence profiles, and allocating the respective portion of the property cost to the corresponding property user. The method may include additional, fewer, or alternative actions, including those discussed elsewhere herein.

In a still further aspect, a property cost allocation (PCA) computing device for allocating property costs between users of a property may be provided. The PCA computing device may include a memory and a processor. The processor and/or an associated transceiver, may be programmed to receive telematics device records from a property telematics unit associated with the property (such as via wireless communication or data transmission over one or more radio links or wireless communication channels). The telematics device records may describe usage of one or more telematics devices, and/or smart devices, associated with the property by at least one property user of a plurality of property users over an interval of time. The processor may also be programmed to generate a presence profile for each property user of the plurality of property users based at least in part upon the telematics device records, the presence profile describing the presence of the respective property user at the property over the period of time. The processor may be further programmed to retrieve insurance rate information associated with each property user, and determine an insurance cost associated with each property user based at least in part upon the respective presence profile and insurance rate information associated with each property user. The processor may also be programmed to allocate each insurance cost to the respective property user. The processor may be programmed to perform additional, fewer, or alternative actions, including those discussed elsewhere herein.

In yet another aspect, a computer-implemented method for allocating property costs between users of a property may be provided. The method may be implemented using a property cost allocation (PCA) computing device including a processor in communication with a memory. The method may include, via the processor and/or an associated transceiver, receiving telematics device records from a property telematics unit associated with the property (such as via wireless communication or data transmission over one or more radio links or wireless communication channels). The telematics device records may describe usage of one or more telematics devices, and/or smart devices, associated with the property by at least one property user of a plurality of property users over an interval of time. The method may also include generating a presence profile for each property user of the plurality of property users based at least in part upon the telematics device records, the presence profile describing the presence of the respective property user at the property over the period of time. The method may further include retrieving insurance rate information associated with each property user, and determining an insurance cost associated with each property user based at least in part upon the respective presence profile and insurance rate information associated with each property user. The method may still further include allocating each insurance cost to the respective property user. The method may include additional, fewer, or alternative actions, including those discussed elsewhere herein.

In another aspect, a property cost allocation (PCA) computing device for managing payment of property costs for users of a shared property may be provided. The PCA computing device may include a memory and a processor (and/or an associated transceiver). The processor may be programmed to determine a respective portion of a property cost to be allocated to each property user of a plurality of property users associated with a property, the property cost associated the property over a predetermined interval of time. The processor may also be programmed to access a respective pre-paid account associated with each property user, and transmit instructions (using the transmitter) to a respective financial institution associated with each pre-paid account (such as via wireless communication or data transmission over one or more radio links or wireless communication channels) to withdraw or transfer funds corresponding to the respective portion of the property cost. The processor may be programmed to perform additional, fewer, or alternative actions, including those discussed elsewhere herein.

In a further aspect, a computer-implemented method for managing payment of property costs for users of a shared property may be provided. The method may be implemented using a property cost allocation (PCA) computing device including a processor and/or associated transceiver in communication with a memory. The method may include, via the processor, determining a respective portion of a property cost to be allocated to each property user of a plurality of property users associated with a property, the property cost associated the property over a predetermined interval of time. The method may also include accessing a respective pre-paid account associated with each property user, and transmitting instructions (via the transceiver) to a respective financial institution associated with each pre-paid account (such as via wireless communication or data transmission over one or more radio links or wireless communication channels) to withdraw or electronically transfer funds corresponding to the respective portion of the property cost. The method may include additional, fewer, or alternative actions, including those discussed elsewhere herein.

In one aspect, a property cost allocation (PCA) computing device for allocating property costs between users of a property may be provided. The PCA computing device may include a memory and a processor (and/or an associated transceiver). The processor may be programmed to receive telematics device records from a property telematics unit associated with the property. The telematics device records may describe usage of one or more telematics devices (and/or associated smart devices) associated with the property by at least one property user of a plurality of property users over an interval of time. The processor may also be programmed to generate a presence profile for each property user of the plurality of property users based at least in part upon the telematics device records, the presence profile describing the presence of the respective property user at the property over the period of time. The processor may be further programmed to retrieve insurance rate information associated with each property user, and determine a usage-based insurance cost associated with each property user based at least in part upon the respective presence profile and insurance rate information associated with each property user. The processor may still further be programmed to transmit, using the transceiver (such as via wireless communication or data transmission over one or more radio links or wireless communication channels), each usage-based insurance cost to a respective user computing device associated with each property user of the plurality of property users for review by the property user to facilitate allocating the usage-based insurance cost between the plurality of property users. The processor may be programmed to perform additional, fewer, or alternative actions, including those discussed elsewhere herein.

In another aspect, a computer-implemented method for allocating property costs between users of a property may be provided. The method may be implemented using a property cost allocation (PCA) computing device including a processor and/or associated transceiver in communication with a memory. The method may include, via the processor and/or transceiver, receiving telematics device records from a property telematics unit associated with the property (such as via wireless communication or data transmission over one or more radio links or wireless communication channels). The telematics device records may describe usage of one or more telematics devices and/or other smart devices associated with the property by at least one property user of a plurality of property users over an interval of time. The method may also include generating a presence profile for each property user of the plurality of property users based at least in part upon the telematics device records, the presence profile describing the presence of the respective property user at the property over the period of time. The method may further include retrieving insurance rate information associated with each property user, and determining a usage-based insurance cost associated with each property user based at least in part upon the respective presence profile and insurance rate information associated with each property user. The method may also include, via the processor and/or transceiver, transmitting (such as via wireless communication or data transmission over one or more radio links or wireless communication channels) each usage-based insurance cost to a respective user computing device (or mobile device) associated with each property user of the plurality of property users for review by the property user to facilitate allocating the usage-based insurance cost between the plurality of property users. The method may include additional, fewer, or alternative actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. In addition, although certain steps of the exemplary processes are numbered, having such numbering does not indicate or imply that the steps necessarily have to be performed in the order listed. The steps may be performed in the order indicated or in another order. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary shared property system;

FIG. 2 illustrates a schematic diagram of an exemplary property cost allocation (PCA) computing device that may be used in the shared property system shown in FIG. 1;

FIG. 3 illustrates a schematic diagram of an exemplary property that may be used in the shared property system shown in FIG. 1;

FIG. 4 illustrates a data flow diagram showing exemplary payment management functionality of the PCA computing device shown in FIG. 2;

FIG. 5 illustrates an exemplary configuration of an exemplary user computing device shown in FIG. 1, in accordance with one embodiment of the present disclosure;

FIG. 6 illustrates an exemplary configuration of an exemplary server computer device shown in FIG. 1, in accordance with one embodiment of the present disclosure;

FIG. 7 illustrates a flow chart of an exemplary computer-implemented method for allocating property costs between users of a property, using the shared property system shown in FIG. 1; and

FIG. 8 illustrates a diagram of components of one or more exemplary computing devices that may be used in the shared property system shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for dividing and allocating property costs between users of a property. In situations where multiple people occupy and/or regularly use a property, there may be a desire to divide and allocate property costs associated with that occupation and/or use. For example, in a situation where multiple roommates share a co-leased (or co-owned) space, there may be a desire to split such costs as the lease cost, an insurance cost (e.g., for renter's insurance), and/or additional costs associated with the shared property. As another example, when multiple businesses occupy respective spaces within a shared building and/or co-lease the same spaces, there may be a desire to similarly divide costs. At least some property uses may view usage- and/or occupancy-based costs sharing as a more “equitable” option than, for example, equal division of every cost. Accordingly, there is a need for determining each property user's respective usage of the property to divide and allocate costs in this manner.

The shared property systems and methods described herein are directed to implementing a cost-sharing structure based upon a plurality of property policies that apply to and are accepted by all users of a property. These “property policies” may define who is responsible for particular portions of property-related costs, such as asset, insurance, utility, maintenance, facility, and/or other property costs. For example, some costs may be split evenly between all property users all of the time (e.g., a maintenance cost for a new shared-use appliance such as a dishwasher or refrigerator). Other costs may be divided and allocated based upon individual and/or multi-user use (e.g., baseline utility costs). Some costs may be divided and allocated based upon certain risk factors (e.g., insurance costs divided and allocated based upon how often each property user is present and/or their respective risk factors). Still other costs may be fully allocated to a single user (e.g., facility costs such as gym-access costs may be only allocated to the property user that uses the gym).

In one embodiment, pro-rated insurance payments based upon property usage between joint owners from separate households may be provided by using a telematics device. Pro-rated lease payments may also be provided using the telematics device and the resulting telematics data generated by the telematics device. Incentives may be tailored to policyholders with shared ownership and/or rental of a residence to encourage safer or risk averse behaviors.

In one exemplary embodiment, these property policies may be automatically generated (e.g., by the shared property system). Additionally or alternatively, the property policies may be manually edited, updated, and/or requested by one or more property users in a “setup” or “registration” phase. This registration phase may occur when the property users become property users of the property (e.g., upon signing a lease). In another embodiment, this registration phase may occur when the property users choose to register with a property cost allocation service. In some embodiments, changes to one or more property policies may require approval of at least one other party, such as an insurance underwriter or a lessor.

In the exemplary embodiments, the property cost allocation services may be provided and performed by a property cost allocation (PCA) computing device. The PCA computing device may process the property policies to determine how to divide and allocate costs associated with the property between the property users. The PCA computing device may communicate with a property telematics unit associated the property and/or with the property users (e.g., using one or more computing devices associated with respective property users) to track property usage by the property users and associated property costs. The PCA computing device may then divide property costs in accordance with the property policies, and allocate respective portions of the property costs to the property users. In some embodiments, the property users may manage payment of the property costs. In other embodiments, the PCA computing device may manage payments, for example, by transmitting withdrawal and transfer instructions to respective financial account(s) associated with the property users.

“Property,” as used herein, may refer generally to any residential or commercial building (and/or other property type) and/or to particular spaces therein. For example, a property may include (but is not limited to) a home, an apartment, a condominium, one or more offices, one or more floors of a building, “common areas” (e.g., lobbies, stairwells, conference rooms, etc.), etc. Moreover, in some embodiments, a shared property may refer additionally or alternatively to vehicles (including automobiles, cars, trucks, boats, RVs, snowmobiles, ATVs, etc.), storage space, lawn equipment, trailers, campers, tools (e.g., table saws, lathes, etc.), and/or personal property (e.g., computers, accessories, etc.).

“Property user,” as used herein, may refer generally to a person having a contractual and/or financial responsibility for a property. Property users may include, for example, lessees, renters, and/or owners/mortgage paying users, of a residential and/or commercial property. Property users may be distinguished from non-user “visitors,” such as visitors to a property user's home or customers at a property user's business. Visitors may have a relatively transient presence at the property (e.g., compared to a property user) and may have no financial/contractual obligation to the property.

“Telematics device,” as used herein, may refer generally to any device configured to collect data associated with the property and/or to transmit that collected data to a property telematics unit. “Telematics” may refer to the technology of sending, receiving, and/or storing information via telecommunication devices, for example, to control a remote object and/or communicate data about a remote object. Telematics devices may include, for example, sensors (e.g., thermometers, light sensors, motion sensors, proximity sensors, smoke detectors, carbon monoxide detectors, etc.), “Internet of Things” (IoT) connected devices (e.g., connected/programmable thermostats, lights, alarms, garage doors, appliances, etc.), meters (e.g., timers, utility meters, etc.), routers, modems, and/or any other such device. The telematics devices discussed herein may also include smart devices, such as smart electronics, smart appliances, smart water meters, smart electricity meters, and/or smart thermostats that may include usage data and time of use data (such as to allow a processor to assign use of water, electricity, air conditioning, heat, appliances, electronics, etc. to specific users or groups of individuals). Telematics (and/or smart) device(s) may be physically present at the property and/or may be remote from the property with a communication link (e.g., wired and/or wireless connection over one or more radio links or communication channels) to the property telematics unit.

The “property telematics unit,” as used herein, may refer to a central interface and “hub” (or smart home controller) through which one, some, or all of the individual telematics (and/or smart) devices associated with the property may be accessed and/or programmed. The property telematics unit, as described further herein, may collect, receive, retrieve, access, and/or transmit data from one, some, or all of the telematics devices communicatively connected thereto (e.g., via a wired and/or wireless connection). Where “property telematics unit” is used herein, the term may refer to the central hub and interface and/or to one or more telematics devices accessible therethrough. In some embodiments, the property telematics unit may include a device physically present at the property that is a dedicated property telematics unit. In some embodiments, the property telematics unit may additionally or alternatively include a user computing device (e.g., smartphone or tablet) having one or more software applications (“apps”) downloaded and installed thereon such that the user computing device may function as the property telematics unit.

“App,” as used herein, may refer generally to a software application installed and downloaded on a user interface of the property telematics unit and/or a user computing device associated with a property user. An app associated with the shared property system, as described herein, may be understood to be maintained by the shared property system and/or one or more components thereof. Accordingly, the “maintaining party” of the app may be understood to be responsible for any functionality of the app and may be considered to instruct other parties/components to perform such functions via the app. In the exemplary embodiment, the app enables and/or requires the user computing device on which the app is installed and/or downloaded to pair with the property telematics unit (e.g., using a wireless connection, such as a Bluetooth® connection, or any other connection). “Pairing,” as used herein, may refer generally to registering a connection between the property telematics unit and a user computing device such that the user computing device may be recognized by the property telematics unit as that particular user computing device, and/or such that the user computing device may communicate with the property telematics unit (e.g., to input information to the property telematics unit and/or receive information from the property telematics unit). “Dispute,” as used herein, may refer generally to any challenge or disagreement with any portion of the property costs that are allocated to a property user.

### Asset Costs

“Asset costs” may be associated with the actual property itself, and how the property users are permitted to use the property. For example, asset costs may include lease costs, purchase costs (e.g., down payments and/or monthly payments), and/or rental costs. Asset costs may be determined according to an owner of the property (e.g., a landlord). Asset costs may be divided and/or allocated to property users, according to one or more property policies.

In some embodiments, according to a particular property policy, asset costs may be divided and allocated evenly between all property users. In such cases, each property user pays equally for the same access to, privilege of, and responsibilities for the property. This may be considered, for some, to be a “typical” asset cost arrangement. For example, many roommates may split rent costs equally therebetween.

In certain embodiments, according to one property policy, asset costs may be divided and allocated according to the space accessible to and/or used by each property user. For example, in an apartment, if a first “roommate” property user has a bedroom that is larger than a bedroom of a second roommate, the first roommate may have slightly more of the asset cost allocated thereto, based upon how much larger their bedroom is.

In other embodiments, according to another property policy, asset costs may be divided and allocated based upon actual usage of the property by each property user. In some embodiments, “usage” may refer to “presence” at the property, when used in relation to asset costs. For example, take a User A that works from home and therefor is present at the property for 90% of their time (e.g., in one week, month, or another interval). User B, User A's roommate at the property, is a student and is only present at the property for about 50% of their time. In this example, asset costs may be divided and allocated according to presence, in about a 9:5 ratio. In other words, User A may be allocated about 64% of the rent (or other asset cost), and User B may be allocated about 36% of the rent. In cases where “property” refers to a non-building property, “usage” may refer to direct usage of the property (e.g., the amount of time a vehicle or article of personal property is actually used by and/or in the care of one or more property users).

Some property policies may combine equal-division, space-based, and/or usage-based allocation methods for particular spaces within the property and/or in particular circumstances. For example, two businesses co-lease office space in a building and share a conference room and lobby. A portion of the asset cost that may be associated with the shared lobby space may be divided equally between the two businesses. A portion of the asset cost that may be associated with the conference room may be divided based upon usage of the conference room, such that the business that uses the conference room more frequently and/or for a greater amount of time (e.g., within one week, month, or another interval) pays proportionally more of that portion of the asset cost. As another example, if both roommates that co-lease an apartment will be on vacation for the same week, the asset cost associated with that amount of time (e.g., within a month-long interval) may be divided equally between the roommates.

### Insurance Costs

“Insurance costs” may be associated with an insurance policy associated with use of the property, and may be typically determined based upon a risk level associated with individual property user(s) and/or with the property itself (e.g., the adequacy of particular safety or prevention features within the property). Insurance costs may be divided and/or allocated to property users, according to one or more property policies associated with insurance costs.

Insurance costs may be determined by an insurance provider of the insurance policy. Individual risk levels, and associated insurance rates for each property user, may be determined based upon behavior, such as hosting large parties or leaving a door unlocked when the property is unoccupied. Accordingly, in at least some embodiments, insurance rates for property users may change over time in reaction to changes in behavior of those property users. In some embodiments, every “new” property user (e.g., a property user that has not yet had an insurance policy with the insurance provider) may have a baseline insurance rate associated therewith. The baseline insurance rate may be applied for one or more “preliminary intervals” (e.g., a first three months of a new policy), during which the property user's behavior and associated risk level are determined. After the preliminary intervals, an individual insurance rate (which may be greater than, less than, or equal to the baseline insurance rate) may be issued for the property user.

In some embodiments, according to a particular property policy, insurance costs may be divided and allocated evenly between all property users. Insurance costs, in such cases, may be determined by the shared property system based upon input from the insurance provider regarding an average risk level attributable to all property users collectively. In these embodiments, the property user with the highest associated individual risk level may benefit unduly, as their share of the risk that contributes to the insurance cost is being shared between all property users. Likewise, the property user with the lowest associated individual risk level may be disadvantaged, as they may pay more of an insurance cost than they would if only their individual risk level were taken into account.

In other embodiments, according to other property policies, different divisions and allocations of insurance costs are contemplated. In a first exemplary property policy, each property user may pay a percentage of the total insurance cost that is attributable to their respective share of a “total” user-based (e.g., property-independent) risk level. As a result, insureds may be rewarded for exhibiting risk averse behaviors. Take a set of three property users, for instance. User A is a relatively low-risk individual and contributes only 20% of the total risk level for the set of property users. User B is a moderate-risk individual and contributes 30% of the total risk level. User C is high-risk individual and contributes 50% of the total risk level. In this first exemplary property policy, regardless of any actual usage of the property, User A pays 20% of the total insurance cost, User B pays 30% of the total insurance cost, and User C pays 50% of the total insurance cost. In some of these embodiments, a total insurance cost may be determined based upon an average risk level associated with the average risk level attributable to all property users collectively. The total insurance cost may then be divided and allocated as described above. However, in such cases, User C may be disadvantaged if their actual usage of the property (e.g., the amount of time they are present at the property) is much less than that of User A and/or User B.

As a second exemplary property policy, insurance costs may be split based upon actual usage or presence, as described above with respect to asset costs. In some of these embodiments, a total insurance cost is determined based upon an average risk level associated with the average risk level attributable to all property users collectively. The usage of each property user may be determined, as described further herein, and the total insurance cost may be divided and allocated between the property users based upon their usage. For example, taking the same set of property users described above, each property user is present at the property for a particular percentage of their total time. For instance, User A is at the property for about 90% of their time over a month-long interval, User B is at the property for about 50% of their time over the interval, and User C is at the property for about 75% of their time over the interval. Based upon their usage, User A should pay about 42% of the total insurance cost, User B should pay about 23% of the total insurance cost, and User C should pay about 35% of the total insurance cost.

According to another exemplary property policy, an insurance rate is calculated over an interval (e.g., a week, month, etc.) based upon who is present and their associated risk level/insurance rate (e.g., for a renter's insurance policy). For example, taking the same set of property users described above, each property user has an associated insurance rate based upon their respective risk level. User A has the low risk level and a particular insurance rate, such as $15, for instance, for a month-long interval. User B has a slightly higher risk level and a particular insurance rate, such as $22. User C has the highest risk level and a particular insurance rate, such as $30. Moreover, User A is at the property for about 90% of their time over the month-long interval, User B is at the property for about 50% of their time over the interval, and User C is at the property for about 75% of their time over the interval. Based only upon their usage, the property users would pay the portions described above with respect to usage. However, factoring in their respective insurance rates, User A should pay about $6.30, User B should pay about $11, and User C should pay about $10.50. In this situation, the total insurance cost is not calculated beforehand and divided, but rather is allocated based upon the insurance cost calculated using the combination of usage and relative risk level.

### Utility Costs

“Utility costs” may be associated with the usage of public utilities, such as electricity, water, gas, sewer systems, trash pick-up services, etc. Utility costs may be generally incurred on a per-property (e.g., per-home or per-apartment) basis according to utility rates set by a utility provider (e.g., an electric company or gas company, etc.) and the amount of the utility used at the property. Utility costs may be divided and/or allocated to property users, according to one or more property policies. It should be understood that certain utilities may be divided and allocated according to one property policy while one or more other utilities may be divided and allocated according to another property policy. For example, electricity and gas utility costs may be divided and/or allocated based upon usage, whereas trash and/or sewer utility costs may be divided and/or allocated equally.

In some cases, property users pay for utilities as part of their asset costs, in a “utilities included” arrangement. In these cases, utility costs are divided and allocated as part of the asset costs, as opposed to being divided and allocated separately.

According to one property policy, a utility cost may be divided and allocated equally between the property users. It should be understood that, in some such cases, property users that use less of one or more utilities may be disadvantaged.

Thus, according to another property policy, a utility cost may be split based upon actual usage of the utility by each property user. In some embodiments, one or more telematics devices is installed at the property to monitor usage of the associated utility. In some cases, a greater number or particular placement of telematics devices may enhance the monitoring of the utility. For example, if telematics devices are installed to monitor electricity usage, one sensor telematics device may be dedicated to each outlet and/or to a circuit designated for a particular room or appliance. The sensor telematics device may be configured to monitor the amount of electricity that passes therethrough for use. Accordingly, the usage of electricity in one bedroom that is only associated with one property user may be directly attributable to that property user. However, usage of utilities in common spaces, such as a kitchen or shared bathroom, may be less simple to attribute to a particular user. In some embodiments, usage of a utility in such shared spaces may be equally divided and/or allocated between the property users that are present at the property when the utility is in use. In such embodiments, one or more telematics devices may be installed to monitor the usage of that utility in a shared space, such that the portion of the utility usage attributable to the shared space may be tracked and identified.

Additionally or alternatively, total (or partial) usage of one utility may be equally divided and/or allocated between not all property users but only between property users present at the property when the utility is in use. In these cases, the property user(s) present at the property at any particular time is determined as described herein, and the amount of a utility used during that time may be divided and/or allocated between those user(s). In some cases, such as for heating or cooling a property even when no user is physically present at the property, such “property unoccupied” utility costs may be divided and/or allocated equally between all property users associated with the property. However, the shared property system may include functionality allowing a property user to dispute partial utility costs being allocated thereto if such utility costs were directly attributable to one other property user. For example, if one property user leaves many lights on or forgets to turn the heat down when they leave the property, the other property users may dispute being allocated utility costs associated with the subsequent “property unoccupied” periods of time. If it can be shown that only the “forgetful” property user was present at the property to cause the use of the utility, the dispute may be settled in favor of the other property users.

In some embodiments, a certain amount of utility usage—a “baseline” utility usage—is not attributable to particular use of the property but rather is attributable to a baseline state of the property. For example, the electricity to keep a refrigerator running and to keep the clock on a microwave on is part of the baseline utility usage. The baseline utility usage for a property may be determined by monitoring the usage of a particular utility when the property is completely unoccupied, such as a month in which an apartment is not being leased by any party. The baseline utility usage for the property may additionally or alternatively be determined using the baseline utility usage for similar properties (e.g., properties having a similar size). In some embodiments, a portion of each utility may be determined to be a baseline utility usage, and that portion may be equally divided and/or allocated between all property users associated with a property.

### Maintenance Costs

“Maintenance costs” may be associated with regular, scheduled maintenance of a property (e.g., lawn maintenance) as well as will incidental maintenance (e.g., replacing an appliance or window). Maintenance costs may be divided and/or allocated to property users, according to one or more property policies associated with maintenance costs.

In one exemplary property policy, maintenance costs may be divided and allocated equally between all property users associated with the property, because maintenance performed on any component of a property may benefit all property users equally. In another exemplary embodiment, certain maintenance costs, such as replacement of a fixture in a space that only one property user uses, may be allocated only to one particular property user. In yet another embodiment, usage of particular appliances may be monitored using one or more telematics devices. In such cases, maintenance costs associated with that appliance may be divided and/or allocated based upon usage of the appliance by each property user.

### Facility Costs

“Facility costs” may be associated with additional fees charged in accordance with optional use of particular amenities of a property. For example, facility costs may include, but are not limited to pet fees, gym or other recreational facility access fees, parking fees assessed on a per-space basis, storage fees, laundry fees, administrative fees, delivery fees, etc. Facility costs may be divided and/or allocated to property users, according to one or more property policies associated with facility costs.

In one exemplary property policy, facility costs may be divided and/or allocated only to those property users that are accessing the associated amenities. For example, one property user may own a pet, and accordingly a monthly pet “rent” or a lump-sum pet “fee” may be charged to the property that the property user shares with their roommate property users. The property user may identity themselves as the owner of the pet—and, therefore, as the source of the associated facility cost—such that the facility cost of the pet rent/fee may be allocated only to that property user. As another example, two of three property users that co-lease a property may access a gym facility, thereby accruing a gym access facility cost. Those two property users may identify themselves as the users of the gym—and, therefore, as the source of the associated facility cost—such that the facility cost of the gym access fee may be allocated only to those property users. If the third property user wishes to use the gym on a one-time or infrequent bases, they may pay a portion of the facility cost associated with each visit, or the other property users may agree to allow the third property user such infrequent access without altering the payment allocation.

In another exemplary property policy, one or more facility costs may be divided and/or allocated evenly between property users. For example, if all property users share a storage space, the property users may have an associated storage facility cost divided and allocated evenly between them. It should be readily understood that different property policies may be applied to different facility costs, such that certain facility costs are divided equally between property users and other facility costs are not divided equally, for the same set of property users.

### Other Costs

It is contemplated that there may be additional and/or alternative costs associated with a property that may be shared, divided, and/or allocated between a group of property users. Each of these other costs may have associated property policies describing the appropriate allocation thereof between the property user(s). The property policies may allocate costs evenly or unevenly (e.g., according to usage and/or presence).

### Determining Usage of a Property by Each Property User

In at least some cases, as described herein, a property user being present at the property and/or making use of the property may cause one or more costs to be allocated to that property user. For example, insurance costs, asset costs, and/or utility costs may be set, divided, and/or allocated in a particular way depending upon which property user(s) are present in the property at a particular time and/or for a particular duration of time. Accordingly, it may be beneficial to employ one or more methods of determining which property user(s) are present at the property at any given time.

In the exemplary embodiment, the property may include (e.g., have physically present at the property or in a location associated with the property) a property telematics unit that allows the property to communication with other devices, for example, via the Internet or any other wired or wireless connection (e.g., Bluetooth®) over one or more radio links or wireless communication channels. In the exemplary embodiment, the property telematics unit may be in communication with one or more telematics devices associated with the property (e.g., one or more sensors, one or more IoT-connected appliances, a wireless router, etc.). The property telematics unit may additionally or alternatively be in communication with one or more user computing devices that are each associated with one of the property users. In some embodiments, the property telematics units may have “application pairing” functionality, such that property users may engage with an app on a user interface at the property telematics unit and/or on their user computing device (e.g., their smartphone or tablet). The property telematics unit may include and/or be in communication with the PCA computing device to transmit information therebetween.

Using the application pairing functionality, the PCA computing device may determine and track which user computing device(s) are present at the property, which may suggest that the property user associated with a user computing device is at the property. For example, each property user may initially pair one or more user computing devices (e.g., smartphones, tablets, laptops, wearables, etc.) to the property telematics unit (and/or may pair with one or more individual telematics devices). The property telematics unit may then subsequently automatically pair with any of those user computing devices that are present at the property. The property telematics unit may record which device(s) pair with the property telematics unit (and/or with one or more individual telematics devices) and the duration of the paired connection. The property telematics unit may send the pairing records to the PCA computing device. The property telematics unit may further record utility usage substantially continuously and send a utility usage record to the PCA computing device.

The PCA computing device may be configured to process and compare these records (referred to “presence records” or “usage records”) to divide and allocate usage-based property costs to each property user. If only one user computing device is paired with the property telematics unit when a utility is consumed (e.g., a light is turned on or an appliance is used), the PCA computing device may associate an entirety of a utility cost associated with that usage to the present property user, wherein the presence is attributed to that property user based upon their paired user computing device. If more than one user computing device is paired with the property telematics unit with a utility is consumed, the PCA computing device may divide and/or allocate the utility cost associated with that usage to the present property users according to a property policy. For example, the PCA computing device may divide and/or allocate the utility cost evenly between the property users. As another example, the PCA computing device may divide and/or allocate the utility cost based upon the location of the utility usage and the property user(s) associated with such a location (e.g., utility cost associated with utility usage in a bedroom may be fully allocated to the property user associated with that bedroom).

In some embodiments, the PCA computing device and/or the property telematics unit may prompt confirmation of a property user's presence or usage of the property by pushing a confirmation request to a paired user computing device. Such a confirmation request may permit the property user to correct mistakes, for example, if a property user is using and accessing a user computing device associated with a different property user.

In some embodiments, the PCA computing device may be configured to detect an anomaly in a property user's presence or usage based upon the pairing of their user computing device. For example, using machine learning functionality, the PCA computing device may determine that one property user is typically away from the property from 8AM to 5:30 PM on weekdays. If their user computing device remains paired to the property telematics unit during that time and/or for a particular threshold period of time (e.g., an hour or two hours between 8 AM and 5:30 PM), the PCA computing device may identify an anomaly. The PCA computing device may cause a confirmation request to be pushed to the user computing device and/or to an alternative contact device. For example, the PCA computing device may cause a phone message to be sent to a work phone number associated with that property user, because the property user may have forgotten their smartphone at home that day. Such an alternative message may only be transmitted if an initial confirmation request is transmitted to the paired user computing device (e.g., the smartphone) and no response is received within a period of time (e.g., an hour). In these embodiments, the property user may confirm that they are present at the property (e.g., they are taking a sick day) and/or may indicate that they are not present. If the property user indicates that they are not present, the PCA computing device may generate an additional presence record or “exception record” identifying that the user is not present or using the property despite the paired user computing device, which may overrule or overwrite the presence record. Additionally or alternatively, the PCA computing device may provide functionality (e.g., using the app and/or through a browser) for a property user to manually enter an exception to their presence record. For the example in which the property user has left their smartphone at home during their work day, the property user may access the app and/or a browser to push an exception record to the PCA computing device. The exception record may include a user-identified period of time during which the property user was not present at the property even though their user computing device was paired therewith.

It should be understood that many property users may have multiple user computing devices, such as a smartphone, a tablet, and a laptop. A property user may pair each of these user computing devices to the property telematics unit and/or to one or more individual telematics devices, such that the property user may access the telematics features thereof (e.g., to control an IoT appliance from any one of these user computing devices). In such cases, a property user may identify one of these three user computing devices as their “presence” user computing device, which is the most likely to accurately reflect their presence at or absence from (i.e., usage of) the property, such as a smartphone or other mobile device. Accordingly, although their laptop and tablet may remain continuously paired to the property telematics unit (e.g., these user computing devices are almost always left at home), the property telematics unit may not use these user computing devices to generate paired device records.

In some embodiments, the property telematics unit may be in communication with a wireless router at the property, the wireless router configured to provide access to a wireless Internet connection at the property. The property telematics unit may record which user computing device(s) pair with the wireless router and the duration of such pairing, in order to generate a paired device record. The property telematics unit may be configured to identify paired and non-paired user computing devices that access the wireless router, such that non-user visitors may be readily identified. If one or more non-user visitors are identified and only one property user computing device is identified, any property costs generated by those non-user visitors (e.g., utility costs associated with utility usage) may be attributed to the one property user present at the property. This assumes that the present property user has invited the non-user visitors into the property, such that the non-user visitors are associated with the present property user.

In some embodiments, the property telematics unit (e.g., under instruction from the PCA computing device via the app) may transmit a visitor confirmation request to the paired user computing device associated with a property user. The visitor confirmation request may request the property user to identify which property user(s) the non-user visitors are associated with. In this way, non-user visitors that are associated with all property users, such as a repairman, may have associated property costs distributed between all property users, not just one or more present property users. In some embodiments, an insurance rate associated with one or more property users may be adjusted based upon the presence of a non-user visitor at the property, to account for an unknown risk level of the non-user visitor.

Another method of determining the presence of a property user at the property may include providing property user-specific keys. When the property is initially accessed by the set of property users (e.g., when the property users move into an apartment or first access a shared vehicle), each may receive a user-specific key fob (or other device, such as a mobile device, i.e., smartphone or wearable electronics), which is registered to that specific user. The property users may sign a contract or other agreement that each property user will only use the key specific to his- or herself, which may encourage the property users to carefully and consistently only use their specific key. When the user-specific key is employed to unlock an entrance to the property (e.g., either manually or electronically, such as through a remote garage door opener or an electronic door lock), the property telematics unit may record which key is used, and, therefore, may indicate to the PCA computing device which property user is present at and/or using the property. Additionally or alternatively, proximity-sensitive tracking may be used to determine which user-specific key is at the property (e.g., within a certain distance range of the property telematics unit). In these embodiments, even when a property user does not user their user-specific key to open an entrance, the property telematics unit may still record their presence.

Moreover, in some embodiments, the PCA computing device, the property telematics unit, and/or a paired user computing device may be configured to track presence characteristics of property users. “Presence characteristics” may include, for example, time and/or duration of presence at the property. The PCA computing device may employ a manual-confirmation presence tracking method for a “preliminary period” (e.g., a first month), either alone or in combination with other presence-identifying methods described herein. During this preliminary period, each property user may be required to manually track their presence (e.g., by accessing the app and/or a web site). The PCA computing device may associate certain times and/or durations of presence with particular property users. The PCA computing device may employ machine learning functionality to develop and maintain “presence profiles” for each of the property users. Accordingly, the PCA computing device may use presence profiles to associate records of unidentified presence from the property telematics unit (e.g., a telematics device record generated by a motion sensor or connected appliance that is not associated with a particular property user) with certain property users.

For example, if a telematics device identifies usage when no property user is otherwise identified as being present (e.g., using one of the other methods described herein), the PCA computing device may access the presence profiles for each property user to determine which property user is likely associated with the usage. If only one property user is typically at the property at a time when the usage occurred (e.g., 10:00 AM) based upon the presence profiles, the PCA computing device may associate the unidentified usage with that property user. Additionally or alternatively, the PCA computing device may cause an alert to be transmitted to that property user (and/or to all property users associated with the property) requesting confirmation of their presence at that time. In such situations where all property users deny being present, the PCA computing device and/or property telematics unit may be configured to contact one or more emergency services (e.g., as someone may have broken into the property).

In still other embodiments, the property telematics unit may include and employ one or more biometric sensors to determine which property user is present at and/or using the property. Biometric sensors may include any sensor configured to receive a biological signal uniquely identifying an individual, such as, but not limited to, retinal scanners, fingerprint scanners, facial recognition devices, and weight scales. In one example, the property may have one or more fingerprint scanners or facial recognition devices at an entrance of the property. A property user may use the fingerprint scanner or facial recognition device to identify themselves as present and/or to gain entry to the property.

In some embodiments, if the PCA computing device is unable to determine which property user(s) are present during a particular period of time, the PCA computing device may equally divide all property costs associated with that period of time (e.g., utility costs). This may apply to periods of time in which no property user is determined to be present (e.g., the property is unoccupied) and/or when the PCA computing device is able to determine at least one property user is present but is unable to determine which exact property user(s) are present.

The methods and systems described herein may be implemented using computer programming or engineering techniques including computer software, firmware, hardware, or any combination or subset. As disclosed above, at least one technical problem with current property sharing systems is that there is a need for enabling property users who share responsibilities and access to a property to share property costs. Many property cost payees, such as insurance companies and property managers, may not be equipped to divide and allocate costs, especially when property policies are agreed upon that split costs based upon actual usage. A serious technical problem arises in determining individual property user usage of the property to implement the property policies. More specifically, current systems provide no way to determine presence of a user and associate that presence with usage to split usage-based costs. In addition, there is a need for a system configured to track and aggregate usage and associated costs. The system and methods described herein address these technical problems.

The technical effect of the systems and processes described herein may be achieved by performing at least one of the following steps, with property owner or user permission or affirmative consent: (i) receiving telematics device records from a property telematics unit associated with the property, wherein the telematics device records describe usage of one or more telematics devices associated with the property by at least one property user of a plurality of property users over an interval of time; (ii) generating a total property usage report based at least in part upon the telematics device records, wherein the total property usage report describes the total usage of the property by the plurality of property users over the interval of time; (iii) determining one or more property costs associated with the property over the interval of time based at least in part upon the total property usage report; (iv) determining a respective portion of each property cost attributable to each property user of the plurality of property users based at least in part upon the telematics device records and the property cost; and (v) allocating each respective portion of each property cost to the corresponding property user.

The resulting technical effect is that the property costs associated with use of the property and/or any associated amenities/features are accurately and equitably (e.g., according to the particular set of property users) split between all property users. When costs are divided and allocated according to explicitly agreed-upon property policies, the frequency of disputes over cost allocation may be reduced. A solution to the above-described problems provided by the shared property system is determination of which property user(s) are using a property at any time, such that usage- or presence-based policies may be implemented by the shared-property system. The shared-property system includes a plurality of methods for determining who is using and/or present at the property, as described more fully herein. Some of these methods including using sensor and/or biometric data, assessing other presence indicators such as paired devices and/or user-specific keys, and requesting confirmation of user presence from a property user. Moreover, by managing payments using the systems and methods described herein, the property users may be ensured precise and accurate payment of only their share of the property costs.

### Exemplary System

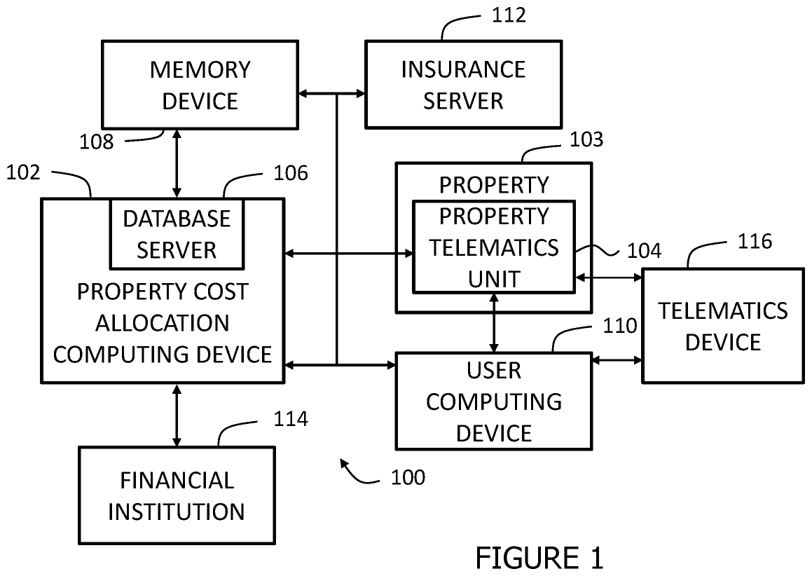

FIG. 1 depicts a schematic diagram of an exemplary shared property system 100. Shared property system 100 is configured to enable tracking of property usage associated with a property 103 and divide and allocate those costs between one or more property users associated with the property 103. In one exemplary embodiment, shared property system 100 may include and/or facilitate communication between one or more property cost allocation (PCA) computing devices 102, a property telematics unit 104 associated with (e.g., physically located in/at) property 103, a memory device 108, one or more user computing devices 110 (each associated with a respective property user, not shown), an insurance server 112, and one or more financial institutions 114.

PCA computing device 102 may be any device capable of interconnecting to the Internet, including a server computing device, a mobile computing device or “mobile device,” such as a smartphone, a personal digital assistant (PDA), a tablet, a wearable device (e.g., a “smart watch” or a personal projection device such as “smart glasses”), a “phablet,” or other web-connectable equipment or mobile devices. Components of shared property system 100 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. In one embodiment, property telematics unit 104 may include PCA computing device 102. In other words, PCA computing device 102 may be located in property 103.

Additionally, a database server 106 may be connected to memory device 108 containing information on a variety of matters. For example, memory device 108 may include such information as presence records, utility usage records, presence profiles associated with respective property users, rolling or progressive property costs, allocated costs associated with the respective property users, property policies, financial account and/or payment information associated with the respective property users, paired user computing devices, presence characteristics, dispute records, and/or any other information used, received, and/or generated by shared property system 100, as described herein. In one exemplary embodiment, memory device 108 may include a cloud storage device, such that information stored thereon may be accessed by one or more components of shared property system 100, such as, for example, PCA computing device 102, user computing device 110, insurance server 112, and/or property telematics unit 104. In one embodiment, memory device 108 may be stored on PCA computing device 102. In any alternative embodiment, memory device 108 may be stored remotely from PCA computing device 102 and may be non-centralized. Moreover, in any alternative embodiment, memory device 108 may be stored on insurance server 112.

PCA computing device 102 may be in communication with property telematics unit 104, one or more user computing device 110, insurance server 112, and/or one or more financial institutions 114, such as via wireless communication or data transmission over one or more radio frequency links or wireless communication channels. In the exemplary embodiment, user computing devices 110 may be computers that include a web browser or a software application to enable PCA computing device 102 and/or property telematics unit 104 to access user computing devices 110, and vice versa, using the Internet or a direct connection, such as a cellular network connection. More specifically, user computing devices 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computing devices 110 may be any device capable of accessing the Internet including, but not limited to, a desktop computer, a mobile device (e.g., a laptop computer, a personal digital assistant (PDA), a cellular phone, a smartphone, a tablet, a phablet, netbook, notebook, smart watches or bracelets, smart glasses, wearable electronics, pagers, etc.), or other web-based connectable equipment. Additionally, user computing devices 110 may be communicatively coupled to PCA computing device 102, property telematics unit 104, and/or more or more telematics devices 116 through many interfaces including, but not limited to, a direct cable connection, a Bluetooth® connection, and a Wi-Fi connection.

In the exemplary embodiment, property telematics unit 104 includes a communication interface (not shown in FIG. 1) such that, with customer or user permission or affirmative consent, property telematics unit 104 may communicate with PCA computing device 104, user computing devices 110, memory device 108, insurance server 112, and/or one or more telematics devices 116 for example, via the Internet. Telematics devices 116 may include, for example, sensors (e.g., thermometers, light sensors, motion sensors, proximity sensors, smoke detectors, carbon monoxide detectors, etc.), “Internet of Things” (IoT) connected devices (e.g., connected/programmable thermostats, lights, alarms, garage doors, appliances, etc.), meters (e.g., timers, utility meters, etc.), routers, modems, and/or any other such device, and may include smart devices, such as smart electronics, smart appliances, smart water meters, smart electricity meters, and/or smart thermostats that may include usage data and time of use data. Property telematics unit 104 may further include a user interface (not shown in FIG. 1) such that property users of property 103 may access certain features of property telematics unit 104 (e.g., the communication interface, one or more apps, one or more telematics devices 116 in communication therewith, etc.).

As described herein, property 103 may be associated with a plurality of property users that share one or more costs associated with property 103, in exchange for use of property 103. For example, the property users may be co-owners, co-lessees, and/or co-renters of property 103 and/or one or more spaces therein (e.g., office space). The property users may sign and/or agree upon one or more property policies that describe how costs will be divided and allocated between one another, various examples of which are provided herein. It should be understood that although property 103 is illustrated as a building, property 103 may additionally or alternatively include one or more vehicles (including automobiles, cars, trucks, boats, RVs, snowmobiles, ATVs, etc.), storage space(s), lawn equipment, trailers, campers, tools (e.g., table saws, lathes, etc.), and/or personal property (e.g., computers, accessories, etc.).

In some embodiments, PCA computing device 102 may be associated with a cost allocation service. Property users may register or sign up with the cost allocation service to access the cost allocation functionality of PCA computing device 102. In some embodiments, PCA computing device 102 may be associated with an insurance company (e.g., associated with insurance server 112). Property users may be provided the cost allocation functionality of PCA computing device 102 upon purchasing an insurance policy associated with property 103 (e.g., a renter's policy, a homeowner's policy). In some embodiments, PCA computing device 102 is associated with management company and/or rental agency of property 103, such that property users may be provided the cost allocation functionality of PCA computing device 102 upon purchasing, leasing, and/or renting property 103.

Property users and/or another party (e.g., a landlord or rental agency) may transmit the property policies to PCA computing device 102. PCA computing device 102 may process the property policies and store the property policies in memory device 108. In some embodiments, PCA computing device 102 may be configured to divide and allocate every property cost associated with property 103 on behalf of the property users. In other embodiments, PCA computing device 102 may be configured to divide and allocate less than all of the property costs associated with property 103, as decided upon by one or more property users. For example, property users may request that PCA computing device 102 divide and allocate all property costs associated with actual usage of property 103 (e.g., utility costs, insurance costs, etc., in some examples), but not any property costs that will be split evenly between the property users (e.g., maintenance costs, in some examples). It should be understood that PCA computing device 102 may be configured to divide and allocate any combination of property costs associated with property 103.

In some embodiments, PCA computing device 102 may be further configured to manage payment(s) of one or more property costs on behalf of the property users. In such embodiments, each property user may maintain a payment account associated with the cost allocations services of PCA computing device 102, as described herein. PCA computing device 102 may withdraw and/or cause withdrawal of funds in amounts corresponding to the respective allocated portions of property costs. PCA computing device 102 may further transfer and/or cause transfer of those funds to one or more parties associated with the property costs (e.g., an insurance provider associated with the insurance cost, a management company or financial institution 114 associated with asset costs, a repair service associated with a maintenance cost, etc.). In some embodiments, PCA computing device 102 may alternatively withdraw or electronically transfer funds in amounts corresponding to the respective allocated portions of property costs and transfer those funds to one financial account (e.g., maintained at a financial institution 114 associated with PCA computing device 102), and may further cause payments to be made to other parties from that one financial account.

In other embodiments, the property users maintain respective payment accounts at respective financial institutions 114. PCA computing device 102 may be configured to transmit instructions to each financial institution 114 to transfer the amount of funds corresponding to the respective property user's portion of one or more property cost(s) to a financial institution 114 associated with that one or more property cost(s). In still other embodiments, PCA computing device 102 may divide and allocate property costs between the property users, as described herein, and transmit a message to each property user (e.g., to a user computing device 110 associated therewith) indicating the respective amounts of each property cost to be paid by that property user to an associated party. In other words, PCA computing device 102 may not manage the transfer of funds but may indicate to the property users how much they are obliged to pay each party according to their property policies.

Financial institution 114 may include any financial institution associated with any component of shared property system 100, one or more property users, and/or a party to which payment is owed according to the property cost(s) associated with property 103. For example, financial institution 114 may include a bank, at which one or more payment account(s) is maintained, that payment account(s) associated with any component of shared property system 100, one or more property users, and/or a party to which payment is owed according to the property cost(s) associated with property 103.

Insurance server 112 may be associated with and/or maintained by an insurance provider, which provides an insurance policy associated with property 103. Insurance server 112 may communicate with PCA computing device 102, property telematics unit 104, telematics device(s) 116, user computing device(s) 110, and/or memory device 108 in order to transmit and/or receive information associated with the insurance policy. For example, insurance server 112 may transmit insurance cost information associated with the respective property users to PCA computing device 102. As another example, insurance server 112 may retrieve usage report information from memory device 108 to analyze the presence profile and/or other usage information of one or more property users, for example, to update an insurance policy associated with property 103 and/or an insurance rate associate with a property user.

### Exemplary Property Cost Allocation Computing Device

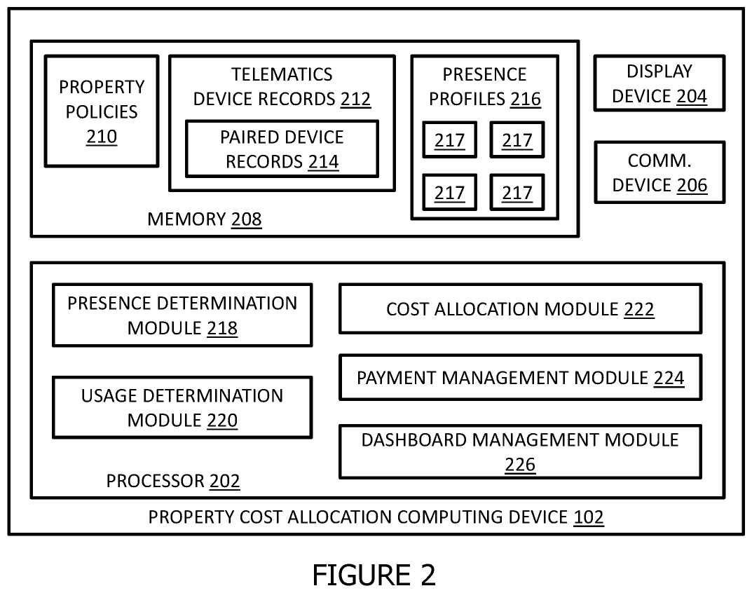

FIG. 2 depicts a schematic diagram of an exemplary PCA computing device 102 (as shown in FIG. 1). In one exemplary embodiment, PCA computing device 102 may include a processor 202, a display device 204, a communication device 206, and a memory 208 (which may be similar to memory device 108, shown in FIG. 1). Processor 202 may be configured to execute a plurality of modules, as described further herein.

Display device 204 may be configured to display output from processor 202. Display device 204 may include a physical display device (e.g., a screen or monitor) and/or may include computer-executable instructions that, when executed, cause display of a virtual user interface, for example, at a user computing device 110 and/or at property telematics unit 104 (both shown in FIG. 1). In other words, display device 204 may include functionality to display an app, including an interactive user interface, at another computing device, to enable input to PCA computing device 102 as well as display of output from PCA computing device 102.

Communication device 206 may be any device configured to enable communication between PCA computing device 102 and any other computing device (e.g., user computing device 110, property telematics unit 104, etc.) over a wired or wireless connection. Communication device 206 may include, for example, a wired or wireless network adapter and/or a wireless data transceiver for use with a mobile telecommunications network.

Memory 208 may be configured to store information, such as, for example, property policies 210, telematics device records 212 (e.g., utility usage records, facility usage records, etc.) including paired device records 214, and/or presence profiles 216. Property policies 210 may be received and/or stored during and/or after a registration phase, in which property users receive and/or agree upon each property policy 210. Each property policy 210 describes how the property users have agreed to handle, divide, allocate, and/or otherwise manage property costs. Telematics device records 212 may be describe output from one or more telematics devices 116 (shown in FIG. 1), such as various sensors, meters, or IoT devices associated with property 103. Telematics device records 212 may be received from property telematics unit 104 and/or one or more individual telematics devices 116 and stored in memory 208.

Paired device records 214 may represent a specific sub-set of telematics device records 212 describing a temporal history of which user computing device(s) 110 paired with property telematics until 104 and/or a specific telematics device 116 (e.g., a wireless router). Paired device records 214 may additionally include indications of which property user (if any) is associated with each paired device.

In one exemplary embodiment, presence profiles 216 may describe each property user's presence tendencies associated with property 103. Presence profiles 216 may be generated by presence determination module 218. Each presence profile 216 may include one or more presence records 217. Presence records 217 represent records generated by presence determination module 218 to identify, based at least in part upon telematics device records 212, which property user(s) are present at the property at any time and/or for how long.

Telematics device records 212, presence profiles 216, and/or presence records 217 may be associated with usage of property 103 within a predetermined interval of time, such as, for example, a billing period, a month, two months, two weeks, or any other interval of time. It should be understood that memory 208 may be configured to store more, less, and/or different information, including any other information described herein.

In one exemplary embodiment, processor 202 may include a presence determination module 218, a usage determination module 220, a cost allocation module 222, a payment management module 224, and a dashboard management module 226. It should be understood that these modules are illustrative only, and that any of the functionality of any module described herein may be performed by any other module and/or be generally performed using processor 202.

In one embodiment, usage determination module 220 may be access telematics device records 212 to determine total usage of property 103 by the property users associated therewith. In some embodiments, usage determination module 220 aggregates telematics device records 212 to generate a total property usage report, which describes the total usage of property 103 by the plurality of property users over an interval of time, including, for example, utility usage, facility/amenity access/usage, etc. Additionally or alternatively, usage determination module 220 may access other (additional and/or alternative) information to generate the total property usage report. For example, usage determination module 220 may access (e.g., receive or retrieve) utility bills and/or usage reports of one or more utilities from one or more utility providers, one or more documents such as a contract indicating usage of a property feature or amenity, and/or any other such information.

Based at least in part upon the total property usage report, usage determination module 220 may determine a total property cost associated with property 103 over the interval of time. The total property cost may include a total of all types of costs, including asset costs, utility costs, maintenance costs, insurance costs, and/or facility costs. In some embodiments, determining the total property cost may include accessing and/or processing property policies 210, telematics device records 212, presence profiles 216, contracts or other such documents describing access to property amenities, utility rates, insurance policy information, output from one or more other modules 218, 222, 224, 226, and/or other rate/cost information from a variety of sources.

For example, usage determination module 220 may retrieve any maintenance reports (not specifically shown) stored in memory 208 and associated with property 103, for example, to determine maintenance costs for the interval of time. As another example, usage determination module 220 may determine a total utility cost for the entire interval by accessing utility bills or other utility usage reports provided by a utility provider. As another example, usage determination module 220 may access facility contracts (e.g., gym contracts or pet ownership agreements) and/or other facility-use reports (e.g., generated by property users) to determine a total facility cost for the interval. As yet another example, usage determination module 220 may determine asset costs for the property 103 based upon one or more monthly payments requested by an asset payee (e.g., a management company, landlord, or bank).

In some embodiments, presence determination module 218 may be configured to generate a presence profile 216 for each property user, each presence profile 216 describing the presence characteristics of the corresponding property user, such as a typical time and/or duration of presence at property 103. To generate a presence profile 216, presence determination module 218 may access and process telematics device records 212, including paired device records 214, to determine when each property user was present at property 103.

In one embodiment, using the telematics device records 212 provided by property telematics unit 104, presence determination module 218 may determine and track which user computing device(s) 110 are present at property 103, which may suggest that the property user associated with a user computing device 110 is at property 103. For example, each property user may initially pair one or more user computing devices 110 (e.g., smartphones, tablets, laptops, wearables, etc.) to property telematics unit 104 (and/or may pair with one or more individual telematics devices 116).

Property telematics unit 104 may then subsequently automatically pair with any of those user computing devices 110 that are present at property 103. Property telematics unit 104 may record which device(s) 110 pair with property telematics unit 104 (and/or with one or more individual telematics devices 116) and the duration of the paired connection. Property telematics unit 104 may send paired device records 214 to PCA computing device 102. Property telematics unit 104 additionally send any other telematics device records 212 to PCA computing device 102, including, for example, telematics device records 212 tracking utility usage.

Presence determination module 218 may be configured to process these records 212, 214 to determine the presence of one or more property users at proper 103. If a particular paired device record 214 indicates that a user computing device 110 associated with a property user paired with property telematics unit 104, presence determination module 218 may generate a presence record 217 based thereupon, the presence record 217 indicating the time and/or duration of the presence of the property user at property 103. Presence determination module 218 may generate a plurality of individual presence records 217 to compile one presence profile 216, each presence record 217 corresponding to one “complete instance” of presence at property 103 by a property user (e.g., from entrance at property 103 to exit from property 2013).

In some embodiments, presence determination module 218 and/or property telematics unit 104 (under instruction from PCA computing device 102 via the app) may prompt confirmation of a property user's presence by pushing a confirmation request to a paired user computing device 110. Such a confirmation request may permit the property user to correct mistakes, for example, if a property user is using and accessing a user computing device 110 associated with a different property user. It should be understood that many property users may have multiple user computing devices 110, such as a smartphone, a tablet, and a laptop.

A property user may pair each of these user computing devices 110 to property telematics unit 104 and/or to one or more individual telematics devices 116, such that the property user may access the telematics features thereof (e.g., to control an IoT appliance from any one of these user computing devices 110). In such cases, a property user may identify one of these three user computing devices 110 as their “presence” user computing device 110, which is the most likely to accurately reflect their presence at or absence from property 103, such as a smartphone. Accordingly, although their laptop and tablet may remain continuously paired to property telematics unit 104 (e.g., these user computing devices 110 are almost always left at property 103), property telematics unit 104 does not use these user computing devices 110 to generate paired device records 214.

In some embodiments, property telematics unit 104 may be in communication with a wireless router at property 103, the wireless router configured to provide access to a wireless Internet connection at property 103. Property telematics unit 104 may record which user computing device(s) 110 pair with the wireless router and the duration of such pairing, in order to generate a paired device record 214, from which presence determination module 218 may generate a presence record 217. Property telematics unit 104 may be configured to identify paired and non-paired user computing devices 110 that access the wireless router, such that non-user visitors may be readily identified. If one or more non-user visitors are identified and only one property user computing device 110 is identified, presence determination module 218 may generate a presence record 217 indicating a number of non-user visitors, the time they were present, and/or a duration of their presence. As described herein, doing so may permit allocation of property costs attributable to non-user visitors to the property user(s) associated with those non-user visitors.

In some embodiments, presence determination module 218 may instruct property telematics unit 104 to transmit a visitor confirmation request to a paired user computing device 110 associated with a property user when one or more non-user visitors are detected/identified. The visitor confirmation request may request the property user to identify which property user(s) the non-user visitors are associated with. For example, a repairman fixing a shared appliance may be associated with all property users, while a friend visiting one property user may be only associated with that property user.

Presence determination module 218 may additionally or alternatively access and process telematics device records 212 associated with property user-specific keys. When property 103 is initially accessed by the set of property users (e.g., when the property users move into an apartment), each may receive a user-specific key fob (or other device, such as a mobile device, i.e., smartphone or wearable electronics), which is registered to that specific user. The property users may sign a contract or other agreement that each property user will only use the key specific to his- or herself, which may encourage the property users to carefully and consistently only use their specific key. When the user-specific key is employed to unlock an entrance to property 103 (e.g., either manually or electronically, such as through a remote garage door opener or an electronic door lock), property telematics unit 104 may record which key is used in a telematics device record 212. Presence determination module 218 may generate a presence record 217 for that property user based upon such a telematics device record 212.

Additionally or alternatively, property telematics unit 104 may include one or more proximity-sensitive tracking telematics devices 116 configured to determine which user-specific key is at property 103 (e.g., within a certain distance range of that telematics device 116). In these embodiments, even when a property user does not user their user-specific key to open an entrance, property telematics unit 104 may still generate a telematics device record 212 indicating the detection of the user-specific key at property 103.

In still other embodiments, property telematics unit 104 may include and employ one or more biometric sensors to determine which property user is present at property 103. Biometric sensors may include any sensor configured to receive a biological signal uniquely identifying an individual, such as, but not limited to, retinal scanners, fingerprint scanners, facial recognition devices, and weight scales. In one example, property 103 may have one or more fingerprint scanners or facial recognition devices at an entrance of property 103. A property user may use the fingerprint scanner or facial recognition device to identify themselves as present and/or to gain entry to property 103. Property telematics unit 104 may generate a telematics device record 212 indicating recognition of a particular property user by a biometric sensor at a particular time. Presence determination module 218 may generate a corresponding presence record 217 for that property user indicating presence of the property user at property 103 at that time.

In some embodiments, presence determination module 218 may generate presence records 217 according to property users' self-identified presence at property 103. For example, the app may permit and/or encourage property users to identify and/or confirm when they enter and/or exit property 103. This may be as simple as accessing the app and tapping an “I'm Home” icon on a home screen when the property user enters property 103, and tapping an “I'm Leaving” icon when the property user exits property 103. In some embodiments, upon pairing of the user computing device 110 with property telematics unit 104, property telematics unit 104 (e.g., under instruction from PCA computing device 102 via the app) may push a reminder to the user computing device 110 to prompt the property user to confirm their presence. Some property users may prefer such a method for identifying when they are present and/or confirming presence that may be recorded using property telematics unit 104, as faithful use of such a method may assist the property user in disputing certain property costs allocated thereto.

To generate the presence profile 216, presence determination module 218 may be configured to track presence characteristics of property users. “Presence characteristics” may include, for example, time and/or duration of presence at property 103. Presence determination module 218 may employ the manual-confirmation presence tracking method for a “preliminary period” (e.g., a first month), either alone or in combination with other presence-identifying methods described herein. During this preliminary period, each property user may be required to manually track their presence (e.g., by accessing the app and/or a website). Presence determination module 218 may generate presence records 217 accordingly, and may associate certain times and/or durations of presence with particular property users. Presence determination module 218 may employ machine learning functionality to develop and maintain presence profiles 216 for each of the property users.

Presence determination module 218 may use presence profiles to associate records of telematics device records 212 not associated with any property user (e.g., a telematics device record 212 generated by a motion sensor or connected appliance that is not associated with a particular property user) with certain property users. For example, if a telematics device records 212 indicates usage when no property user is otherwise identified as being present (e.g., using one of the other methods described herein), presence determination module 218 may access presence profiles 216 for each property user to determine which property user is likely associated with the usage. If only one property user is typically at the property at a time when the usage occurred (e.g., 10:00 AM) based upon presence profiles 216, presence determination module 218 may associate the unidentified usage with that property user.

Additionally or alternatively, presence determination module 218 may instruct property telematics unit 104, when a telematics device record 212 is generated without being associated with any property user, to cause an alert to be transmitted to one or more property users associated with property 103 requesting confirmation of their presence at that time. In such situations where all property users deny being present, property telematics unit 104 (e.g., under instruction from PCA computing device 102 via the app) may be configured to contact one or more emergency services (e.g., as someone may have broken into property 103).

In some embodiments, presence determination module 218 may be configured to use presence profiles 216 to detect an anomaly in a property user's presence based upon the pairing of their user computing device 110. For example, in generating the presence profiles 216, presence determination module 218 may determine that one property user is typically away from property 103 from 8 AM to 5:30 PM on weekdays. If their user computing device 110 remains paired to property telematics unit 104 during that time and/or for a particular threshold period of time (e.g., an hour or two hours between 8 AM and 5:30 PM), presence determination module 218 may identify an anomaly.

Presence determination module 218 may instruct property telematics unit 104 to cause a confirmation request to be pushed to the user computing device and/or to an alternative contact device when an anomaly is detected. For example, presence determination module 218 instruct a phone message to be sent to a work phone number associated with that property user, because the property user may have forgotten their smartphone at home that day. Such an alternative message may only be transmitted if an initial confirmation request is transmitted to the paired user computing device 110 (e.g., the smartphone) and no response is received within a period of time (e.g., an hour). If the property user has indicated that they were not present, presence determination module 218 may generate an “exception record” indicating that the user is not present despite the paired user computing device 110, which may overrule or overwrite a presence record 217 generated in accordance with the paired device record 214 for the user computing device 110.

Additionally or alternatively, presence determination module 218 may provide functionality (e.g., using the app and/or through a browser) for a property user to manually enter an exception to their presence record 217. For the example in which the property user has left their smartphone at home during their work day, the property user may access the app and/or a browser to push an exception record to presence determination module 218. The exception record may include a user-identified period of time during which the property user was not present at property 103 even though their user computing device 110 was paired with property telematics unit 104.

In some embodiments, if presence determination module 218 is unable to determine which property user(s) are present during a particular period of time that corresponds to a telematics device record, presence determination module 218 may generate no corresponding presence record 217. Additionally or alternatively, presence determination module 218 may generate an alternative record (not shown) and/or append an indication to the telematics device record 212 indicating that no property user is associated therewith.

Based upon the presence record(s) 217 for each property for the interval of time, presence determination module 218 and/or usage determination module 220 may determine certain property costs associated therewith. For example, usage determination module 220 may access a presence record 217 identifying which property user is associated with one or more non-user visitors. Usage determination module 220 may then attribute one or more property costs generated by non-user visitors (e.g., utility costs associated with utility usage) to that property user.

Cost allocation module 222 may be configured to determine a respective property user cost (i.e., a portion of a total property cost for the interval of time) attributable to each property user. Cost allocation module 222 may retrieve property policies 210 and, based upon the content and directives thereof, divide one or more property costs amongst the property users.

Cost allocation module 222 may divide and allocate certain property costs differently, in accordance with property policies 210. For example, cost allocation module 222 may be configured to divide a total asset cost associated with property 103 during the interval of time evenly between all of the property users. Cost allocation module 222 may be configured to divide a total utility and/or maintenance cost associated with property 103 during the interval of time according to actual usage, based upon telematics device records 212 and presence records 217. As another example, cost allocation module 222 may be configured to determine insurance costs attributable to each property user over the interval of time, based upon presence records 217 and/or presence profiles 216, as well as insurance information (e.g., risk profiles, policy information, and/or insurance rates) associated with each respective property user.

Cost allocation module 222 may transmit instructions to insurance server 112 (shown in FIG. 1) to communicate insurance rates and/or other insurance information to usage determination module 220. Based upon the relative duration of presence at property 103 of each property user, usage determination module 220 may determine a relative portion (e.g., percentage) of a total insurance rate for each property user that the property user may be obligated to pay. In other cases, a total insurance cost may be fixed on a per-interval basis (e.g., SA/month), based upon an average risk level of all property users. Cost allocation module 222 may allocate a portion of the total insurance cost to each property user, for example, based upon the relative duration of presence at property 103 of each property user.

Cost allocation module 222 may be configured to process and compare telematics device records 212, 214 and/or presence records 217 to divide and allocate usage-based property costs to each property user. If a particular paired device record 214 and corresponding presence record 217 (e.g., a presence record 217 that correspond to the same period of time as the paired device record 214) indicates that only one user computing device 110 paired with property telematics unit 104 when a utility is consumed (e.g., a light is turned on or an appliance is used), cost allocation module 222 may associate an entirety of a utility cost associated with that usage to the “present” property user. In this case, the presence is attributed to that property user based upon their paired user computing device 110. If multiple user computing devices 110 are paired with property telematics unit 104 with a utility is consumed, cost allocation module 222 may divide and/or allocate the utility cost associated with that usage to the present property users according to a property policy 210. For example, cost allocation module 222 may divide and/or allocate the utility cost evenly between the property users. As another example, cost allocation module 222 may divide and/or allocate the utility cost based upon a location of the utility usage within property 103 and the property user(s) associated with such a location (e.g., utility cost associated with utility usage in a bedroom may be fully allocated to the property user associated with that bedroom).

Additionally, cost allocation module 222 may be configured to adjust one or more property users allocated to the property users based upon periods of time within the interval of time during which property 103 was unoccupied. Cost allocation module 222 may equally divide all property costs associated with that period of time (e.g., utility costs, asset costs, etc.). The same may apply to periods of time in which no property user is determined to be present (e.g., the property is unoccupied) and/or when usage determination module 220 is able to determine at least one property user is present but is unable to determine which exact property user(s) are present.

Cost allocation module 222 may be further configured to allocate each respective property user cost to the corresponding property user. Each property user cost may include an aggregate of the property user's portions of each property cost, for example, a total amount including a portion of the total insurance cost, a portion of the total asset cost, a portion of the total fuel cost, etc. Additionally or alternatively, each property user cost may include an itemized breakdown of individual property costs, and/or presence records 217 and associated costs.

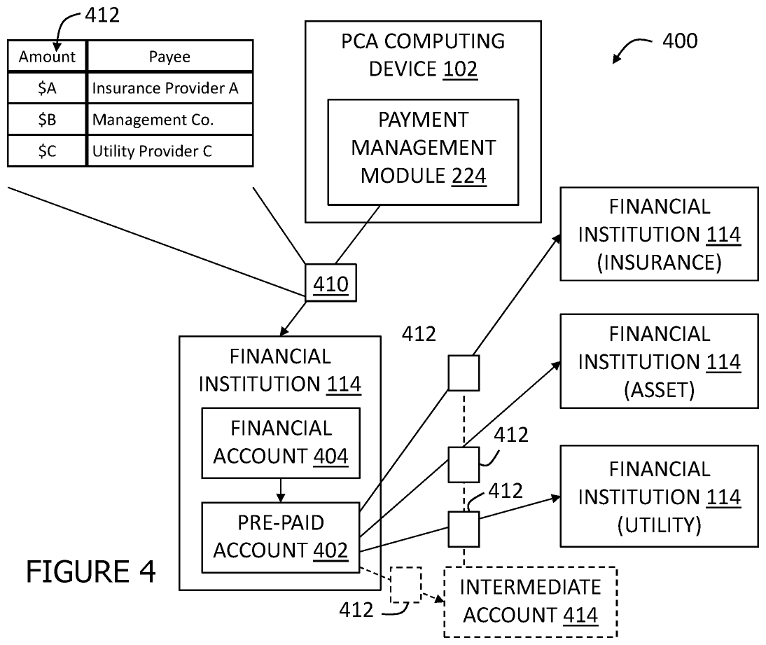

Payment management module 224 may be configured to manage payments of each property user cost, in accordance with one or more property policies 210 and/or in accordance with the wishes of the property users. The functionality of payment management module 224 is described further herein with respect to FIG. 4.

In some embodiments, dashboard management module 226 may be configured to maintain up-to-date costs for each property user and/or an itemized list of presence records 217 and/or any costs associated therewith. Dashboard management module 226 may communicate with display device 204 to display a “dashboard” within the app (e.g., on a user interface of property telematics unit 104 and/or user computing device 110). Each property user may “log-in” to the app to have displayed their own costs data. Moreover, in some embodiments, payment management module 224 may be configured to communication with display device 204 to display bills, reminders, notifications, and/or other information to each property user within the app.

### Exemplary Property

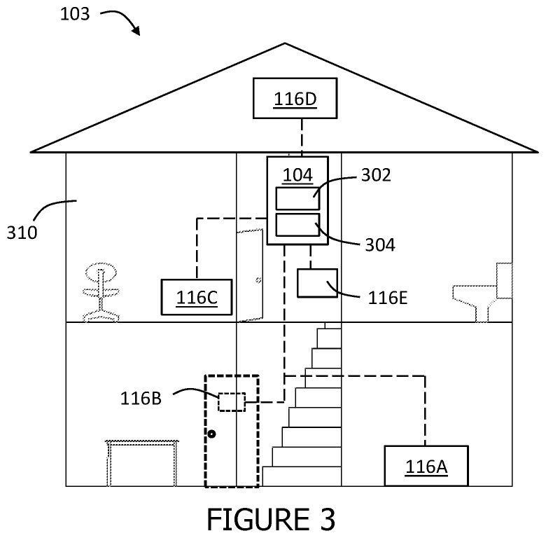

FIG. 3 depicts a view of an exemplary property 103 (shown in FIG. 1). Although property 103 is illustrated as a home or apartment, it should be understood that property 103 may include any other kind of residential and/or commercial property, such as an office building. Moreover, in some embodiments, property 103 may additionally or alternatively include one or more vehicles (including automobiles, cars, trucks, boats, RVs, snowmobiles, ATVs, etc.), storage space(s), lawn equipment, trailers, campers, tools (e.g., table saws, lathes, etc.), and/or personal property (e.g., computers, accessories, etc.).

Property 103 may include a property telematics unit 104 as well a plurality of telematics devices 116A, 116B, 116C, 116D, and 116E (collectively “telematics devices 116”). In the illustrated embodiment, each telematics device 116 may be communicatively coupled to property telematics unit 104, such that each telematics device 116 may transmit records, reports, signals, and/or other data to property telematics unit 104. Property telematics unit 104 may include any computing device capable of interconnecting to the Internet, including a server computing device, a user computing device, a dedicated computing device designed to be a property telematics unit, or other web-connectable equipment or mobile devices.

In one embodiment, property telematics unit 104 may include PCA computing device 102. In other words, PCA computing device 102 may be located in property 103. Property telematics unit 104 may be communicatively coupled to the Internet through a communication device 302. Additionally, property telematics unit 104 may communicate with PCA computing device 102 and/or user computing device(s) 110 using communication device 302. Communication device 302 may include, for example, a wired or wireless network adapter and/or a wireless data transceiver for use with a mobile telecommunications network. Communication device 302 may be configured to communicate using many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, a cable modem, a Wi-Fi connection, and a Bluetooth® connection.

Property telematics unit 104 also includes a user interface 304. User interface 304 may include at least one media output component for presenting information to a property user, such as a display device (e.g., a cathode ray tube (CRT), liquid crystal display (LCD), light emitting diode (LED) display, or “electronic ink” display) or an audio output device (e.g., a speaker or headphones). In some embodiments, the media output component may be configured to present a graphical user interface (e.g., a web browser and/or a client application). User interface 304 may further include an input device 520 for receiving input from a property user, such as, for example, a keyboard, a pointing device, a mouse, a stylus, and/or a touch sensitive panel (e.g., a touch pad or a touch screen).

Telematics devices 116 may include, for example, a wireless router 116A, a biometric sensor 116B, an electricity meter 116C, a proximity sensor 116D, and an IoT connected thermostat 116E. As described herein, wireless router 116A may pair with user computing devices 110 when property users with user computing devices 110 enter property 103. Wireless router 116A may transmit a signal to property telematics unit 104 to generate a paired device record.

Biometric sensor 116B may be used to recognize property users to permit entry to property 103. Biometric sensor 116B may transmit a signal to property telematics unit 104 when biometric sensor 116B recognizes a property user, such that property telematics unit 104 may generate a telematics device record.

Electricity meter 116C may track and monitor all electricity usage within one room 310 of property 103. Electricity meter 116C may continuously or at intervals transmit a signal to property telematics unit 104 indicating electricity usage within room 310. Proximity sensor 116D may sense one or more objects, such as a user-specific key, and transmit a signal to property telematics unit 104 whenever proximity sensor 116D sense the one or more objects.

Connected thermostat 116E may monitor and adjust, for example, HVAC usage according to one or more programmed schedules. Connected thermostat 116E may transmit signals to property telematics unit 104 when connected thermostat 116E adjusts the HVAC.

Property telematics unit 104 may be configured to collect, receive, and/or request data from telematics devices 116. Property telematics unit 104 may generate, process, store, and/or transmit telematics device records, including as described herein.

### Exemplary Payment Management

FIG. 4 illustrates a data flow diagram 400 showing exemplary functionality of PCA computing device 102 (shown in FIGS. 1 and 2). More specifically, FIG. 4 illustrates exemplary payment management functionality of payment management module 224 (shown in FIG. 2) of PCA computing device 102. It should be understood that the functionality described herein is illustrative only and should not be construed to limit the present disclosure.

In one exemplary embodiment, property 103 (shown in FIG. 1) has a plurality of property costs associated therewith, as described herein. Each property cost may be paid to a different payee party. For example, in one embodiment, such payee parties may include, without limitation, an insurance provider (e.g., payee for an insurance cost), a rental management company (e.g., payee for an asset cost), a repair service (e.g., payee for a maintenance cost), and/or a utility provider (e.g., an electric company or gas company). Payee parties may maintain respective financial accounts at financial institutions 114 (shown in FIG. 1). Accordingly, in FIG. 4, three payee parties are represented by their respective financial institutions 114.

In some embodiments, each payee party issues one bill covering the entirety of the property cost associated with that party. For example, a utility provider may issue a single bill for $80 for an electric bill for a particular month. PCA computing device 102, as described above with respect to FIG. 2, may determine what portion of this $80 is attributable to each property user. Payment management module 224 may then issue a “pseudo-bill” to each property user, the pseudo-bill indicating the respective portion of the $80 that must be paid by each property user. In some embodiments, PCA computing device 102 may be configured to receive a bill issued by a payee party and issue “pseudo-bills” to each property user.

In one embodiment, each property user may independently make a payment to the payee party. Continuing with the above example, each property user may independently make a payment to the utility in an amount corresponding to their portion of the $80 charge. In another embodiment, each property user may pay one “representative” property user, who will then make one “lump” payment to the payee party.

In some embodiments, PCA computing device 102 automatically handles payment to the payee party, in accordance with one or more property policies 210 (shown in FIG. 2) and/or other instructions given by each property user. In some cases, one or some of a plurality of property users may choose to use the payment management functionality of PCA computing device 102. In other cases, all of a plurality of property users may choose to use the payment management functionality of PCA computing device 102.

In one embodiment, payment may be rendered by each property user on a prepayment schedule (e.g., whether payment is automatically managed using payment management module 224 or manually by each property user). In other words, payment for a particular interval (e.g., one month) may be rendered prior to that interval (e.g., during the preceding month). However, this may pose some challenge for groups of property users with property policies 210 that divide one or more property costs based upon actual usage of the property 103.

In some embodiments, an equal division of all costs may be allocated for pre-payment for a number of “preliminary” intervals (e.g., the first three months of the cost-sharing structure implemented as set out in property polices 210). During these preliminary intervals, each property user may pay equal portions of the property costs, but actual usage may be tracked and recorded, as described herein. PCA computing device 102 may develop “average usage reports” and/or “average presence report” for each individual property user, for each property policy and/or cost category (e.g., average utility for each property user, average duration present at the property, etc.).

For the first interval after the preliminary intervals, portions of the property costs may be allocated to each property user according to their respective average usage report and property policies 210. Actual usage/presence may be continually tracked, and average usage reports may be continually updated, such that the pre-payment for each interval is a reflection of past actual usage/presence. Each usage report may incorporate usage data maintained for an indefinite period of time. Alternatively, each usage report may incorporate usage data maintained for a particular number of past intervals (e.g., the past six months, the past twelve months, etc.). Additionally or alternatively, each usage report may permit “resetting” of the data incorporated therein, in accordance with certain events (e.g., getting a job, changing job shifts, etc.), such that the usage report may more quickly respond to large changes in actual usage/presence at property 103.

In another embodiment, payment may be rendered on a post-payment schedule directly in accordance with actual usage/presence. Payment may be rendered at regular intervals (e.g., every week, every two weeks, every month, etc.) in accordance with property user preference and/or as required by a particular payee party. PCA computing device 102 may allocate payment amounts based upon determined and/or tracked actual usage/presence in accordance with property policies 210.

In some embodiments, payment management module 224 (and/or property users) may initiate payments to be made (as described herein) in a typical “receive bill for bill amount, pay bill in bill amount with payment account” fashion, at these regular intervals. Additionally or alternatively, payment management module 224 (and/or property users) may initiate payments to be made on a rolling basis (e.g., each day, etc.).

In one exemplary embodiment, payment management module 224 receives (e.g., from cost allocation module 222, shown in FIG. 2) an indication of the respective portions of property costs allocated to (i.e., to be paid by) each property user. Payment management module 224 may access financial account information associated with each property user. Financial account information may be stored (e.g., in memory 108, shown in FIG. 1) in an encrypted and/or anonymized fashion. Payment management module 224 may then access a financial account for each property user.

In one embodiment, each property user maintains a pre-paid account 402 associated specifically with shared property system 100. In some embodiments, this pre-paid account 402 is maintained at the same financial institution 114 as one or more other financial accounts 404 of the property user (e.g., a savings account or checking account). The property user may use financial account 404 to pre-fund pre-paid account 402 with money (whether or not financial account 404 is maintained at the same financial institution 114 as pre-paid account 402). The property user may ensure funds are present in pre-paid account 402, such that payments may be made automatically (e.g., without requesting a specific amount be transferred to pre-paid account 402 before the payment can be made). In some embodiments, payment management module 224 may withdraw payments from pre-paid account 402 in accordance with the portion of each property cost owed by the property user. Pre-paid account 402 may have an alert functionality configured to alert the associated property user when a balance of pre-paid account 402 falls below a particular threshold amount (e.g., $50), to avoid a zero or negative balanced of pre-paid account 402. It should be understood that, in some cases, pre-paid account 402 and financial account 404 may be the same account. In such cases, payments may be made in a typical “automatic bill” fashion, when initiated by payment management module 224 as described herein.

To initiate a payment, payment management module 224 transmits payment instructions 410 to the financial institution 114 at which pre-paid account 402 (and/or any other financial account 404 from which a property user makes payments) is maintained. Payment instructions 410 include one or more payment amounts 412, and cause financial institution 114 to automatically withdraw funds in the payment amount(s) from pre-paid account 402. In some embodiments, payment instructions 410 (as shown in FIG. 4) include a plurality of payment amounts 412, as well as a corresponding plurality of payee parties (e.g., financial accounts details thereof) to which the payment amounts 412 are due. In these embodiments, payment instructions 410 cause financial institution 114 to automatically initiate transfer of funds each payment amount 412 to the corresponding financial institution 114 associated with the payee party to which the payment amount 412 is due.

In another embodiment, to avoid making a plurality of transfers for the payment of a single bill from a payee party, payment management module 224 may include in payment instructions 410 the financial account information of an intermediate account 414. Intermediate account 414 may be associated with PCA computing device 102 and/or shared property system 100. In these embodiments, payment instructions 410 may cause financial institution 114 to automatically transfer funds in each payment amount 412 to intermediate account 414 (e.g., in separate transfers or as a sum of all individual payment amounts 412). Once funds have been transferred to intermediate account 414 from every pre-paid account 402 associated with each property user, such that intermediate account 414 includes funds in a total bill amount due to a payee party, payment management module 224 initiates a transfer of funds from intermediate account 414 to the financial institution 414 of the payee party (e.g., with another set of payment instruction 410).

In some cases, funds may be transferred between pre-paid accounts 402 of property users associated with the same property 103. For example, if one property user “pre-paid” a utility cost for all property users of a group (e.g., paying $40.00 from their pre-paid account and/or any other account), payment management module 224 may be configured to transfer funds associated with the other property users' respective utility costs to the pre-paid account 402 of that property user. In some embodiments, for situations like these and/or for other payments situations (e.g., for maintenance costs), one or more of the property users may maintain a joint account (e.g., a pre-paid account 402 and/or any other financial account 404) from which total bill amounts may be withdrawn.

In one embodiment, the joint account may also be set for maintenance and shared items that would be used to pro-rate costs across leasers. The joint account may be used to pay heating/electrical/water/Internet/cable television/parking/fitness center/child care/and other costs. These costs may be proportional or evenly split. The joint account may also be applied to any other type of shared space that uses a subscription-based feed, such as museums and sporting events.

Additionally, an app may track property use for each of the joint owners/leasers for a shared property. Lease payments and insurance payments may be split accordingly based upon usage each month. Insurance rates may be based upon traditional homeowners rating variables, as well as homeowners telematics data. Usage may also be defined in terms of amount of space used (such as square footage), such as if companies are sharing leased office space. Billing may be embedded within the app or bills may be sent separately—with the app only being used to collect telematics and/or other data, and determine costs.

Further, rates and payments based upon usage may prevent each of the joint owners from paying more than their fair share. Lease payments may automatically be adjusted based upon usage, such as determining who is present in the home based upon a cell or smart phone being connected to Wi-Fi or a home communication network. Risky behavior (e.g., leaving the door unlocked or leaving the heat off in the winter) by one of the joint owners may not unfairly impact the insurance rates of the other joint owners.

### Exemplary User Computer Device

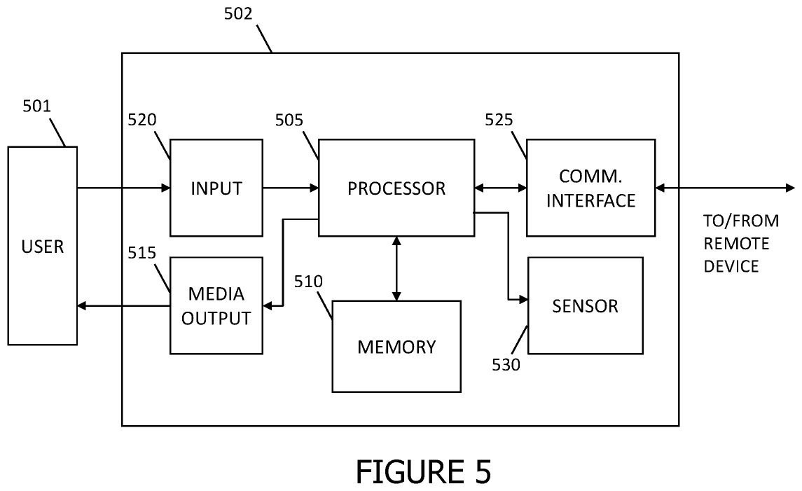

FIG. 5 depicts an exemplary configuration of an exemplary user computer device 502 that may be used with shared property system 100 (shown in FIG. 1), in accordance with one embodiment of the present disclosure. User computer device 502 may be operated by a user 501 (e.g., a property user). User computer device 502 may include, but is not limited to, user computing devices 110, property telematics unit 104, and/or telematics devices 116 (both shown in FIG. 1). User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer-readable media.

User computer device 502 also may include at least one media output component 515 for presenting information to user 501. Media output component 515 may be any component capable of conveying information to user 501. In some embodiments, media output component 515 may include an output adapter (not shown), such as a video adapter and/or an audio adapter. An output adapter may be operatively coupled to processor 505 and operatively coupleable to an output device, such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an application for accessing a telematics device 116, and/or a wallet application for managing payment information.

In some embodiments, user computer device 502 may include an input device 520 for receiving input from user 501. User 501 may use input device 520 to, without limitation, interact with property telematics unit 104 and/or PCA computing device 102 (e.g., using an app), input presence information, and/or request payment information. Input device 520 may include, for example, a keyboard, a pointing device, a mouse, a stylus, and/or a touch sensitive panel (e.g., a touch pad or a touch screen). A single component such as a touch screen may function as both an output device of media output component 515 and input device 520. User computer device 502 further includes at least one sensor 530, including, for example, a gyroscope, an accelerometer, a position detector, a biometric input device, and/or an audio input device.

User computer device 502 may also include a communication interface 525, communicatively coupled to a remote device such as PCA computing device 102 (shown in FIG. 1) and/or property telematics unit 104. Communication interface 525 may include, for example, a wired or wireless network adapter and/or a wireless data transceiver for use with a mobile telecommunications network.

Stored in memory area 510 may be, for example, computer-readable instructions for providing a user interface to user 501 via media output component 515 and, optionally, receiving and processing input from input device 520. The user interface may include, among other possibilities, a web browser and/or a client application. Web browsers enable users, such as user 501, to display and interact with media and other information typically embedded on a web page or a website from PCA computing device 102 and/or property telematics unit 104. A client application may allow user 501 to interact with, for example, PCA computing device 102 and/or property telematics unit 104. For example, instructions may be stored by a cloud service and the output of the execution of the instructions sent to the media output component 515.

### Exemplary Server Device

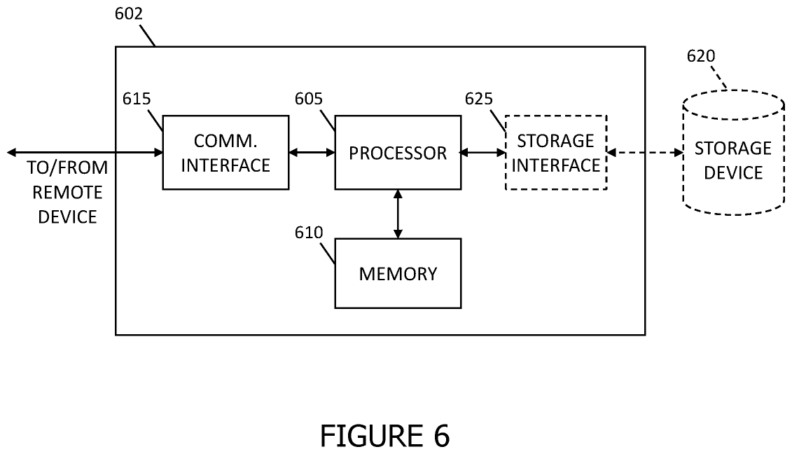

FIG. 6 depicts an exemplary configuration of an exemplary server computer device shown in FIG. 1, in accordance with one embodiment of the present disclosure. A server computer device 601 may include, but is not limited to, database server 106, PCA computing device 102, insurance server 112, and/or property telematics unit 104 (all shown in FIG. 1). Server computer device 601 may include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 may be capable of communicating with a remote device such as another server computer device 601, user computer device 502 (shown in FIG. 5), or PCA computing device 102. For example, communication interface 615 may receive requests from or transmit requests to user computer device 502 via the Internet.

Processor 605 may also be operatively coupled to a storage device 620. Storage device 620 may be any computer-operated hardware suitable for storing and/or retrieving data, such as, but not limited to, data associated with database 108 (shown in FIG. 1). In some embodiments, storage device 620 may be integrated in server computer device 601. For example, server computer device 601 may include one or more hard disk drives as storage device 620.

In other embodiments, storage device 620 may be external to server computer device 601 and may be accessed by a plurality of server computer devices 601. For example, storage device 620 may include a storage area network (SAN), a network attached storage (NAS) system, and/or multiple storage units such as hard disks and/or solid state disks in a redundant array of inexpensive disks (RAID) configuration.

In some embodiments, processor 605 may be operatively coupled to storage device 620 via a storage interface 625. Storage interface 625 may be any component capable of providing processor 605 with access to storage device 620. Storage interface 625 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 620.

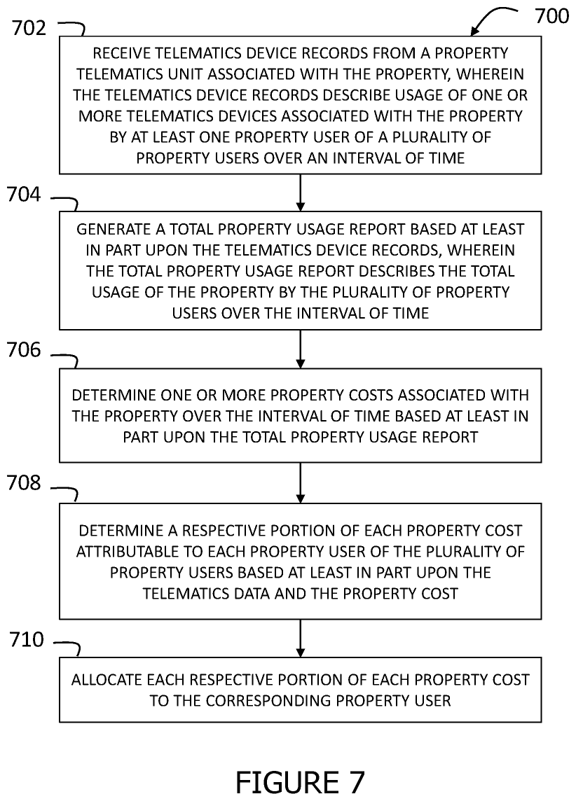

Processor 605 executes computer-executable instructions for implementing aspects of the disclosure. In some embodiments, processor 605 may be transformed into a special purpose microprocessor by executing computer-executable instructions or by otherwise being programmed. For example, processor 605 may be programmed with the instructions such as are illustrated in FIG. 7.

### Exemplary Computer-Implemented Method for Allocating Property Costs Between Users of a Property

FIG. 7 depicts a flow chart of an exemplary computer-implemented method 700 for allocating property costs between users of a property using shared property system 100 shown in FIG. 1. In the exemplary embodiment, method 700 may be performed by PCA computing device 102 (shown in FIG. 1).

Method 700 may include, with user permission or affirmative consent, receiving 702 telematics device records from a property telematics unit associated with the property, such as via wireless communication or data transmission over one or more radio links or wireless communication channels. The telematics device records describe usage of one or more telematics devices (and/or other smart devices) associated with the property by at least one property user of a plurality of property users over an interval of time. Method 700 may further include generating 704 a total property usage report based at least in part upon the telematics device records. The total property usage report describes the total usage of the property by the plurality of property users over the interval of time. Method 700 may also include determining 706 one or more property costs associated with the property over the interval of time based at least in part upon the total property usage report.

Method 700 may still further include determining 708 a respective portion of each property cost attributable to each property user of the plurality of property users based at least in part upon the telematics device records and the property cost. Method 700 may further include allocating 710 each respective portion of each property cost to the corresponding property user.

It should be understood that method 700 may include fewer, additional, and/or alternative steps for allocating property costs between users of a shared property. For example, in some embodiments, method 700 may include at least one of: (i) generating a presence profile for each property user of the plurality of property users based at least in part upon the telematics device records, the presence profile describing the presence of the respective property user at the property over the period of time; (ii) determining a respective portion of a property cost associated with the property over the interval of time attributable to the presence of each property user of the plurality of property users based at least in part upon the respective presence profiles; and/or (iii) allocating the respective portion of the property cost to the corresponding property user.

Exemplary Computer Device for Allocating Property Costs Between Users of a Property

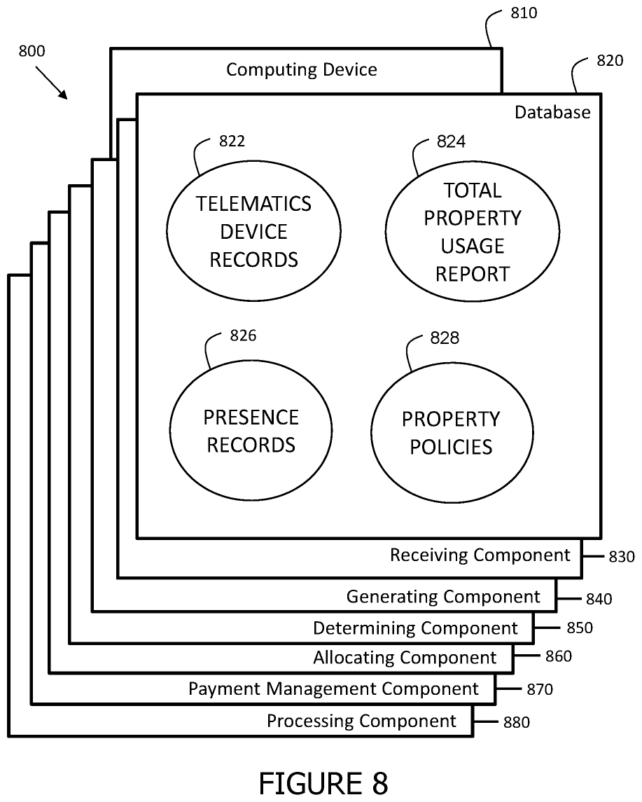

FIG. 8 depicts a diagram 800 of components of one or more exemplary computing devices 810 that may be used in shared property system 100 shown in FIG. 1. In some embodiments, computing device 810 may be similar to PCA computing device 102 (shown in FIG. 1). In the exemplary embodiment, computing device 810 may include a database 820, which may be similar to database 108 (also shown in FIG. 1). Database 820 may include telematics device records 822, total property usage reports 824, presence records 826, and property policies 828. Database 820 may be coupled with several separate components within computing device 810, which perform specific tasks.

In one exemplary embodiment, computing device 810 may include a receiving component 830. In some embodiments, receiving component 830 may include and/or be integral to any kind of communication device (e.g., a transceiver). Receiving component 830 may be configured to receive telematics device records 822 from a property telematics unit (e.g., property telematics unit 104, shown in FIG. 1) associated with the property, such as via wireless communication or data transmission over one or more radio links or communication channels. The telematics device records 822 may describe usage of one or more telematics devices (e.g., telematics device 112, also shown in FIG. 1) associated with the property by at least one property user of a plurality of property users over an interval of time.

Computing device 810 may also include a generating component 840. Generating component 840 may be configured to generate a total property usage report 824 based at least in part upon the telematics device records 822. The total property usage report 824 may describe the total usage of the property by the plurality of property users over the interval of time.

Computing device 810 may further include a determining component 850. Determining component 850 may be configured to determine one or more property costs associated with the property over the interval of time based at least in part upon the total property usage report 824. Determining component 850 may be further configured to determine a respective portion of each property cost attributable to each property user of the plurality of property users based at least in part upon the telematics device records 822 and the property cost.

Computing device 810 may also include an allocating component 860, configured to allocate each respective portion of each property cost to the corresponding property user. Allocating may include, for example, recording the respective property user cost and/or transmitting a message including the respective property user cost to the corresponding property user (e.g., to a user computing device associated with the property user). Computing device 810 may further include, in some embodiments, a payment management component 870. Payment management component 870 may be configured to manage payments of the property user cost(s) to respective payee parties (e.g., an insurance company, a management company or landlord, a repair service, a financial institution, etc.).

Managing payments may include transmitting the message including the respective property user cost, as well as portions of the respective property cost payable to each payee party, such that the property user may pay the payee party. Managing payments may additionally or alternatively including transmitting withdrawal and transfer instructions to one or more financial institutions associated with the property user to cause payment of the property user costs from a financial account of each property user. Additionally, a processing component 880 may assist with execution of computer-executable instructions associated with the system.

### Exemplary Insurance-Related Functionality

In another aspect, a computer-implemented method of allocating property costs between users of a property, as well as improving the functioning of a computer system, may be provided. The method may include receiving, such as via wireless communication or data transmission over one or more radio links or wireless communication channels, telematics device records from a property telematics unit associated with the property, wherein the telematics device records describe usage of one or more telematics devices (and/or other smart devices) associated with the property by at least one property user of a plurality of property users over an interval of time. The method may also include generating a presence profile for each property user of the plurality of property users based at least in part upon the telematics device records, the presence profile describing the presence of the respective property user at the property over the period of time. The method may further include retrieving insurance rate information associated with each property user, and determining an insurance cost (such as a usage-based insurance cost) associated with each property user based at least in part upon the respective presence profile and insurance rate information associated with each property user. The method may also include allocating each insurance cost to the respective property user.

Additionally or alternatively, the method may include generating a plurality of presence records based at least in part upon the telematics device records. Each presence record of the plurality of presence records may describe at least one of a time and duration of presence of a property user at the property. The plurality of presence records may at least in part define the presence profile. The method may include transmitting an indication of each insurance cost associated with each property user to at least one of the property telematics unit and a respective user computing device associated with each property user.

In another aspect, another computer-implemented method of allocating property costs between users of a property may be provided. The method may include receiving, via wireless communication or data transmission over one or more radio links or wireless communication channels, telematics device records from a property telematics unit associated with the property, wherein the telematics device records describe usage of one or more telematics devices (and/or other smart devices) associated with the property by at least one property user of a plurality of property users over an interval of time. The method may also include generating a presence profile for each property user of the plurality of property users based at least in part upon the telematics device records, the presence profile describing the presence of the respective property user at the property over the period of time. The method may further include retrieving insurance rate information associated with each property user, and determining a usage-based insurance cost associated with each property user based at least in part upon the respective presence profile and insurance rate information associated with each property user. The method may still further include transmitting each usage-based insurance cost to a respective user computing device associated with each property user of the plurality of property users for review by the property user to facilitate allocating the usage-based insurance cost between the plurality of property users.

Additionally or alternatively, the method may include generating a plurality of presence records based at least in part upon the telematics device records. Each presence record of the plurality of presence records may describe at least one of a time and duration of presence of a property user at the property. The plurality of presence records may at least in part define the presence profile. The method may also include generating at least one presence record based upon a paired device record of the telematics device records, the paired describing at least one of a time and duration of when a user computing device associated with one property user of the plurality of property users paired with a wireless router at the property. The method may include at least one of: (i) determining, based at least in part upon the telematics device records, a presence of one or more non-user visitors at the property; and (ii) adjusting at least one usage-based insurance cost based upon a duration of the presence of the one or more non-user visitors at the property.

The foregoing methods may include additional, less, or alternate functionality, including that discussed elsewhere herein. The foregoing methods may be implemented via one or more local or remote processors, sensors, transceivers, and/or servers, and/or via computer-executable instructions stored on non-transitory computer-readable media or medium.

### Exemplary Embodiments and Methods

The present embodiments may additionally provide automated payment management of the respective user portions of a total property cost. In these embodiments, PCA computing device 102 may not only determine what each property user is obligated to pay but may manage withdrawal and/or transfer of the appropriate funds to each payee party. Such payment management may save the property users time and effort and may ensure more accurate and timely payment to each payee party.

In one aspect, a computer-implemented method managing payment of property costs for users of a shared property is provided. The method may include (1) determining a respective portion of a property cost to be allocated to each property user of a plurality of property users associated with a property, the property cost associated with the property over a predetermined interval of time; (2) accessing a respective pre-paid account associated with each property user; and/or (3) transmitting instructions to a respective financial institution associated with each pre-paid account to withdraw funds corresponding to the respective portion of the property cost. The method may include additional, less, or alternate functionality, including that discussed elsewhere herein.

For instance, the method may include dividing each respective portion of the property cost into a plurality of payments, each payment of the plurality of payments associated with a different payee. The method may further include transmitting instructions to the respective financial institution associated with each pre-paid account to transfer funds corresponding to each respective payment of the plurality of payments to a payment account of the corresponding payee.

Additionally or alternatively, the method may include identifying a first segment of the property cost, the first segment independent of the respective portions and equally associated with the plurality of property users. For example, the first segment may represent a maintenance cost that is divided equally among the property users regardless of usage. The method may further include accessing a joint pre-paid account associated with the plurality of property users. The method may also include transmitting instructions to a financial institution associated with the joint pre-paid account to withdraw funds corresponding to the first segment of the property cost.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A control system for detecting utility usage using sensor and device pairing data, the control system comprising:
a server computing device comprising a first memory and a first processor; and
a control hub physically located at a property, the control hub in communication with the server computing device, with a distributed network of telematics devices physically located at the property, and with at least one wireless communication device physically located at the property, each telematics device including a respective utility sensor and configured to collect sensor data representing utility consumption and including timestamps associated with the utility consumption, the at least one wireless communication device configured to collect wireless pairing data including timestamps associated with wireless pairing of the wireless communication device with any user computing device, the control hub comprising a second memory and a second processor,
wherein the second processor is programmed to:
continuously receive, from the distributed network of telematics devices, sensor data;
continuously receive, from the wireless communication device, wireless pairing data; and
periodically transmit, to the server computing device, the sensor data and wireless pairing data; and
wherein the first processor is programmed to:
generate, by processing the received sensor data and wireless pairing data using trained machine learning functionality stored within the first memory, a presence profile for each user computing device, the presence profile representing physical presence of a corresponding user of the respective user computing device at the property;
identify, in the received sensor data and wireless pairing data, a presence anomaly;
in response to identifying the presence anomaly, transmit a confirmation request to at least one of the user computing devices;
update the presence profile for each property user computing device using the trained machine learning functionality and a response to the confirmation request; and
cause to be displayed, within a graphical user interface of an application executed on each respective user computing device, a respective portion of the overall utility usage associated with the presence profile of that user computing device.

2. The control system of claim 1, wherein the at least one wireless communication device comprises a wireless router facilitating access by the user computing device to a wireless Internet connection at the property.

3. The control system of claim 1, wherein the first processor is further programmed to train a machine learning model using a training set of verified wireless pairing data and utility sensor data.

4. The control system of claim 3, wherein the first processor or the second processor is further programmed to verify a portion of the wireless pairing data and utility sensor data based on one or more of (i) biometric signals received from at least one biometric telematic device, (ii) user-specific keys used to access the property, or (iii) verification messaging between the first or second processor and the user computing devices.

5. The control system of claim 1, wherein the first processor is further programmed to associate the respective portion of the overall utility usage with each respective user computing device by associating utility usage while each user computing device is present at the property with corresponding utility usage.

6. The control system of claim 1, wherein the first processor is further programmed to:
identify, based upon the received wireless pairing data, an unrecognized user computing device wirelessly paired to the wireless communication device for a period of time;
in response to identifying the unrecognized user computing device present at the property, identify one of the user computing devices present at the property during at least a portion of the period of time; and
transmit, to the identified one of the user computing devices, a user identification request requesting that the user associated with the identified one of the user computing devices identify the unrecognized user computing device.

7. The control system of claim 1, wherein the first processor is further programmed to:
identify, based upon the received wireless pairing data, at least one period of time when none of the user computing devices are present at the property; and
associate an equal portion of utility usage during the at least one period of time to the presence profile of each user computing device.

8. The control system of claim 1, wherein the utility sensor data further includes location data representing a location of the respective telematics device, and
wherein the first processor is further programmed to process the received utility sensor data and wireless pairing data to associate portions of an overall utility usage at the property with a presence of respective user computing devices at the property by allocating utility usage at respective locations associated with corresponding users of the user computing devices to those respective user computing devices.

9. The control system of claim 1, wherein the first processor is further programmed to associate utility usage with the presence of two or more user computing devices during a period of time when the two or more user computing devices are simultaneously paired with the wireless communication device.

10. A computer-implemented method for detecting utility usage using sensor and device pairing data, the method implemented by a control system including a server computing device having a first memory and a first processor, and a control hub physically located at a property, the control hub including a second memory and a second processor, the method comprising:
communicatively coupling the control hub to the server computing device, to a distributed network of telematics devices physically located at the property, and to at least one wireless communication device physically located at the property, each telematics device including a respective utility sensor and configured to collect sensor data representing utility consumption and including timestamps associated with the utility consumption, the at least one wireless communication device configured to collect wireless pairing data including timestamps associated with wireless pairing of the wireless communication device with any user computing device;
continuously receiving, by the control hub from the distributed network of telematics devices, sensor data;
continuously receiving, by the control hub from the wireless communication device, wireless pairing data;
periodically transmitting, by the control hub to the server computing device, the sensor data and wireless pairing data;
generating, by the server computing device by processing the received sensor data and wireless pairing data using trained machine learning functionality stored within the first memory, a presence profile for each user computing device, the presence profile representing physical presence of a corresponding user of the respective user computing device at the property;
identifying, by the server computing device in the received sensor data and wireless pairing data, a presence anomaly;
in response to identifying the presence anomaly, transmitting, by the server computing device, a confirmation request to at least one of the user computing devices;
updating, by the server computing device, the presence profile for each property user computing device using the trained machine learning functionality and a response to the confirmation request; and
causing to be displayed, by the server computing device within a graphical user interface of an application executed on each respective user computing device, a respective portion of the overall utility usage associated with the presence profile of that user computing device.

11. The computer-implemented method of claim 10, further comprising training, by the server computing device, a machine learning model using a training set of verified wireless pairing data and utility sensor data.

12. The computer-implemented method of claim 11, further comprising verifying a portion of the wireless pairing data and utility sensor data based on one or more of (i) biometric signals received from at least one biometric telematic device, (ii) user-specific keys used to access the property, or (iii) verification messaging between the user computing devices and the control hub or server computing device.

13. The computer-implemented method of claim 10, further comprising associating, by the server computing device, the respective portion of the overall utility usage with each respective user computing device by associating utility usage while each user computing device is present at the property with corresponding utility usage.

14. The computer-implemented method of claim 10, further comprising:
identifying, by the server computing device based upon the received wireless pairing data, an unrecognized user computing device wirelessly paired to the wireless communication device for a period of time;
in response to identifying the unrecognized user computing device present at the property, identifying, by the server computing device, one of the user computing devices present at the property during at least a portion of the period of time; and
transmitting, by the server computing device to the identified one of the user computing devices, a user identification request requesting that the user associated with the identified one of the user computing devices identify the unrecognized user computing device.

15. The computer-implemented method of claim 10, further comprising:
identifying, by the server computing device based upon the received wireless pairing data, at least one period of time when none of the user computing devices are present at the property; and
associating, by the server computing device, an equal portion of utility usage during the at least one period of time to the presence profile of each user computing device.

16. The computer-implemented method of claim 10, wherein the utility sensor data further includes location data representing a location of the respective telematics device, the method further comprising processing, by the server computing device, the received utility sensor data and wireless pairing data to associate portions of an overall utility usage at the property with a presence of respective user computing devices at the property by allocating utility usage at respective locations associated with corresponding users of the user computing devices to those respective user computing devices.

17. The computer-implemented method of claim 10, further comprising associating, by the server computing device, utility usage with the presence of two or more user computing devices during a period of time when the two or more user computing devices are simultaneously paired with the wireless communication device.

18. At least one non-transitory computer-readable storage medium having computer-executable instructions embodied thereon, wherein, when executed by a first processor of a server computing device and a second processor of a control hub physically located at a property, the control hub in communication with the server computing device, with a distributed network of telematics devices physically located at the property, and with at least one wireless communication device physically located at the property, each telematics device including a respective utility sensor and configured to collect sensor data representing utility consumption and including timestamps associated with the utility consumption, the at least one wireless communication device configured to collect wireless pairing data including timestamps associated with wireless pairing of the wireless communication device with any user computing device, the computer-executable instructions cause the first and second processors to:
continuously receive, by the second processor from the distributed network of telematics devices, sensor data;
continuously receive, by the second processor from the wireless communication device, wireless pairing data;
periodically transmit, by the second processor to the server computing device, the sensor data and wireless pairing data;
generate, by the first processor by processing the received sensor data and wireless pairing data using trained machine learning functionality stored within the first memory, a presence profile for each user computing device, the presence profile representing physical presence of a corresponding user of the respective user computing device at the property;
identify, by the first processor in the received sensor data and wireless pairing data, a presence anomaly;
in response to identifying the presence anomaly, transmit, by the first processor, a confirmation request to at least one of the user computing devices;
update, by the first processor, the presence profile for each property user computing device using the trained machine learning functionality and a response to the confirmation request; and
cause to be displayed, by the first processor within a graphical user interface of an application executed on each respective user computing device, a respective portion of the overall utility usage associated with the presence profile of that user computing device.

19. The at least one non-transitory computer-readable storage medium of claim 18, wherein the computer-executable instructions further cause first processor to train a machine learning model using a training set of verified wireless pairing data and utility sensor data.

20. The at least one non-transitory computer-readable storage medium of claim 18, wherein the computer-executable instructions further cause first processor to associate the respective portion of the overall utility usage with each respective user computing device by associating utility usage while each user computing device is present at the property with corresponding utility usage.
